(19) United States
(12) Patent Application Publication
(10) Pub. No.: US 2003/0134130 A1
(43) Pub. Date: Jul. 17, 2003

(54) Modified silica compositions, transparent resin compositions and thermoplastic resin laminates and automotive parts formed therefrom, and production method thereof

(75) Inventors: Shoichiro Yano, Ibaraki (JP); Takashi Sawaguchi, Yokohama (JP); Masatoshi Chikazawa, Tokyo (JP); Takashi Takei, Tokyo (JP); Masao Nakajima, Chiba (JP); Kouichi Handa, Kanagawa (JP); Yasuaki Kai, Yokohama (JP); Takashi Seino, Kanagawa (JP); Tomohiro Ito, Kanagawa (JP); Shinkichi Torii, Kanagawa (JP); Katsuhiko Suzuki, Kanagawa (JP); Kenji Uesugi, Kanagawa (JP)

Correspondence Address: FOLEY AND LARDNER, SUITE 500, 3000 K STREET NW, WASHINGTON, DC, 20007, US

(73) Assignees: NISSAN MOTOR CO., LTD.; NIHON UNIVERSITY, SCHOOL JURIDICAL PERSON; TAMA-TLO CORPORATION

(21) Appl. No.: 10/284,335

(22) Filed: Oct. 31, 2002

(30) Foreign Application Priority Data
Oct. 31, 2001 (JP) 2001-334590
Jun. 27, 2002 (JP) 2002-188415

(51) Int. Cl. B32B 9/04

(52) U.S. Cl. 428/447

(57) ABSTRACT

For producing a modified silica composition, finely particulate silica with silanol groups is used. The finely particulate silica is so modified as to have a modification factor of 0.45 to 8 as expressed by the product (A×B) of the hydrophobic ratio (A) of its silanol groups and the total carbon number (B) of alkyl groups. It makes with a matrix resin a transparent resin composition of high transparency and rigidity which can make a thermoplastic resin laminate having an excellent appearance and suitable for application to a part for the exterior decoration of a vehicle.

### BACKGROUND OF THE INVENTION

1. Field of Invention

This invention relates to a modified silica composition having alkyl groups bonded to a part of silanol groups, a transparent resin composition containing such a silica composition and a thermoplastic resin laminate of high transparency and rigidity made by employing such transparent resin composition.

2. Description of Related Art

Methacrylic, polycarbonate, styrene and epoxy resins are known as transparent resins which are useful for optical applications including the preparation of organic glass, or plastic lenses. Organic glass is characterized by its superiority to inorganic glass in impact resistance, lightness in weight and moldability, and the methacrylic resins have, among others, been increasing in the purposes and amount of use owing to their high light transmittance, low light scattering property, high transparency and high weatherability.

Japanese Patent Application Laid-Open No. 11-343349 discloses a resin window pane formed from a transparent resin composition (C) obtained by adding fine particles of silica having a diameter not exceeding the wavelength of visible light to a transparent amorphous organic polymer to improve its physical properties including rigidity. The transparent resin composition (C) composed of fine particles of silica and an organic polymer is obtained by adding fine particles of silica dispersed in a solvent during the process of producing a transparent amorphous organic polymer, while mixing the reactants, and causing sedimentation with a solidifying solvent, and the polymerization reaction for producing a polymer may be of suspension, solution, emulsion or bulk polymerization, while methyl methacrylate, etc. are disclosed as monomers for producing a transparent amorphous organic polymer.

Japanese Patent Application Laid-Open No. 6-316045 discloses synthetic resin safety glass obtained by employing a three-layer laminated sheet consisting of a (meth)acrylic resin sheet, a thermoplastic polyurethane sheet and a polycarbonate sheet and laying a laminated film consisting of a (meth)acrylic resin film and a polycarbonate film on each side of the (meth)acrylic resin sheet so that the (meth)acrylic resin film may contact the (meth)acrylic resin sheet. The invention disclosed therein is aimed at providing synthetic resin safety glass having an improved adhesion between its synthetic resin sheets and intermediate layers and preventing the loss of clarity or the transmission of a distorted image by its (meth)acrylic resin sheet at a high temperature in a hot pressing process and the scattering of any of its (meth)acrylic resin portions by a strong force of impact.

Japanese Patent Application Laid-Open No. 6-71826 discloses a glazing material for vehicles having a hardened surface film formed directly or on a primer layer on the surface of a laminated structure composed of a layer of a specific glutarimide and methyl methacrylate copolymer, or a methacrylic resin and a layer of a transparent polymer of high impact strength, such as a polycarbonate.

The known organic glass and composite materials are, however, lower in rigidity than inorganic glass, and if they are used to make a large item of which a certain level of rigidity is required, such as a front window pane for a vehicle, it is necessary to make it with a large thickness contrary to the desired reduction in weight. The addition of a filler, such as glass fiber, to achieve an increased strength results in a reduction of transparency making it difficult to ensure visibility.

Referring to the application of those organic resinous materials to products, organic glass has the advantage of being light in weight and allowing a high degree of freedom in molding as compared with the inorganic materials, but its drawbacks are a low rigidity due to a low elastic modulus, a reduction of quality in appearance due to warpage caused by the relaxation of the residual stress of the molding operation at a high temperature, and a low hardness making an easily damaged surface. Therefore, there is, for example, no transparent resinous material that is satisfactory in properties for application to window panes occupying a considerably large area in the exterior surface of a motor vehicle, though there is a material used for a small part which may be relatively low in rigidity and is easily capable of surface treatment, such as the headlamp or sunroof.

Referring to the resinous parts for the exterior or interior decoration of a motor vehicle, other than the window panes, there is a demand of increasing severity for improvements in physical properties and cost reductions, including a reduction of quality in appearance due to warpage, clearance narrowing, etc. caused by the relaxation of any residual stress at a high temperature, impact strength such as cracking resistance, and a reduction in weight of parts for an improved fuel consumption. Improvements by lamination have been under way in addition to any attempt relying upon a single resin alone for responding to such a demand for improvements in physical properties, and it is considered that lamination makes it possible to create a product of high added value at a low cost, and that unitary molding including any surrounding part makes it possible to achieve a reduction in the number of parts and thereby in the cost of manufacture.

Although the lamination of three kinds of transparent resins provides an improved impact strength, however, the laminated structure as described in Japanese Patent Application Laid-Open No. 6-316045 is likely to show a reduction of quality in appearance due to unevenness caused by stretching at a high temperature in summer, or warpage caused by expansion when applied to any part forming the interior or exterior of a motor vehicle, since the maintenance of transparency does not allow the addition of any filler for restraining thermal expansion at an elevated temperature.

Japanese Patent Application Laid-Open No. 6-71826 discloses a resin window pane made by laminating (meth)acrylic and polycarbonate resins, etc., but its thermal expansion is difficult to restrain satisfactorily, since the maintenance of transparency of the resins does not allow the addition of any filler for restraining their thermal expansion. The maintenance of transparency does not allow the addition of any filler for improved rigidity, such as glass fiber, but an increased thickness is required for improved rigidity with a resultant increase of weight contrary to the desired weight reduction.

### SUMMARY OF THE INVENTION

Accordingly, it is an object of the present invention to provide a transparent resin composition of excellent transparency and improved rigidity and a method for producing the same.

It is another object of the present invention to provide a transparent, highly rigid and scratch-resistant resin laminate which is free from any thermal deformation or warpage at a high temperature, and a method for producing the same. When an organic resinous material is used for making a large part, such as a window pane, door, or body plate for a motor vehicle, it is necessary to make any such part with a large thickness, since the material is lower in rigidity than any inorganic material, and the use of resinous materials fails to be very effective for achieving a reduction of weight as an important object, though it may ensure a high degree of freedom in molding. It is, therefore, an object of the present invention to provide a transparent resin composition which exhibits improved rigidity without calling for any increase in thickness, and therefore makes it possible to achieve a reduction in weight, while also having a high elastic modulus.

If an organic resinous material is used for making a large part, such as a window pane for a motor vehicle, it is necessary to employ a structural design for relieving any surrounding steel part from thermal strain, since the material undergoes heavier thermal deformation due to the relaxation of the residual stress of the molding operation at a high temperature than any inorganic material. If the structure does not satisfactorily absorb any stretching caused by thermal deformation, a resinous pane may have a corrugated surface, or even crack. Thus, it is an object of the present invention to provide a transparent resin composition giving a resinous material having a low coefficient of thermal expansion.

In view of the fact that the addition of any known inorganic filler to any part lowers its transparency by increasing the reflection, scattering and absorption of transmitted light, it is another object of the present invention to provide a modified silica composition which can improve the elastic modulus of any transparent resinous material and lower its coefficient of thermal expansion, while maintaining its transparency.

Moreover, an organic resinous material is lower in hardness than steel, and if it is used for making any part having a surface exposed to any contact by people, or any other different material, such as a window pane, outside plate, interior decoration, or building material for a motor vehicle, it is necessary to form a resinous surface having an improved scratch resistance. Thus, it is an object of the present invention to provide a resinous material having high rigidity, a low coefficient of thermal expansion and high scratch resistance, and capable of being shaped as desired in accordance with design data and at a low cost, and a method for producing the same. It is still another object of the present invention to provide a molded product of any such resin composition, a part for a motor vehicle and a method for producing the same.

The resin composition of the present invention can be used to make a resinous wiper system, a resinous door mirror stay, a resinous pillar, a resinous window with heat rays, a resinous mirror, a resinous lamp reflector, a resinous engine compartment cover or casing, an engine compartment cover or casing, or a resinous cooler part.

The modified silica composition of the present invention and the transparent resin composition containing the same have been developed and studied in view of an improved affinity of silica as an inorganic material added to a matrix resin. As a result, there has been found an approach which makes it possible to obtain improved strength and a lower coefficient of thermal expansion, while maintaining transparency. The use of this material for industrial applications in the fields of, say, motor vehicles, electric appliances, or house construction makes it possible to achieve a reduction in weight of various parts and a high degree of freedom in shaping. For example, it can replace inorganic glass for the window panes of a motor vehicle and contribute greatly to a reduction in weight of the vehicle and the creation of novel designs. If they are made as laminated structures, they are still improved in mechanical properties, and contribute to a reduction in weight of the vehicle, thereby a reduction of fuel consumption and a reduction of CO₂ production, and eventually global environmental preservation.

### BRIEF DESCRIPTION OF DRAWINGS

FIG. 1 is a perspective view of a motor vehicle equipped with exterior decoration molded parts produced in accordance with the present invention;

FIGS. 2A and 2B are perspective and top views of a motor vehicle equipped with outer plate members produced in accordance with the present invention;

FIG. 3 is a perspective view of a motor vehicle equipped with window panes produced in accordance with the present invention;

FIG. 4 is a view of a wiper system including parts produced in accordance with the present invention;

FIG. 5 is a perspective view of a motor vehicle equipped with a plurality of combined parts produced in accordance with the present invention;

FIG. 6 is a view of an instrument panel produced in accordance with the present invention;

FIG. 7 is a top view of a motor vehicle equipped with heat-ray heater installed parts produced in accordance with the present invention;

FIG. 8 is a sectional view of a head lamp unit equipped with a reflector produced in accordance with the present invention;

FIG. 9 is a top view of an engine compartment that includes various parts produced in accordance with the present invention;

FIG. 10 is a view showing parts installed in the engine compartment, which are produced in accordance with the present invention;

FIG. 11 is a view showing various parts of an engine cooling system, which are produced in accordance with the present invention;

FIG. 12 is a view showing other parts of the engine cooling system, which are also produced in accordance with the present invention;

FIGS. 13A and 13B are perspective views of motor vehicles, each being equipped with various exterior hollow parts produced in accordance with the present invention;

FIGS. 14A and 14B are views of an interior of a motor vehicle, which is equipped with various interior hollow parts produced in accordance with the present invention;

FIG. 15 is a view of an instrument panel having an air duct, which is produced in accordance with the present invention;

FIG. 16 is a view of an automotive roof equipped with parts produced in accordance with the present invention;

FIG. 17 is a perspective view of a radiator core support produced in accordance with the present invention;

FIGS. 18A and 18B show a throttle valve device having a shaft-integrated valve plate produced in accordance with the present invention; and

FIG. 19 shows a fuel tank and its associated parts, which are produced in accordance with the present invention.

### DETAILED DESCRIPTION OF THE INVENTION

According to a first aspect of the present invention, there is provided a modified silica composition containing finely particulate silica so modified as to have a modification factor of 0.45 to 8 obtained as the product (A×B) of the hydrophobic ratio of silanol groups (A) and the total carbon number of alkyl groups (B). The hydrophobic ratio (A) of the silanol groups is the ratio of hydrogen atoms contained in the silanol groups of finely particulate silica and replaced by alkyl groups, and is a number exceeding 0, but not exceeding 1. The total carbon number (B) of the alkyl groups is the total number of the carbon atoms in the alkyl groups added by replacing the hydrogen atoms in the silanol groups directly.

If, for example, finely particulate silica having the structure shown by the left formula below is modified with dimethyldichlorosilane to give a modified silica composition as shown by the right formula below, the composition has a silanol hydrophobic ratio (A) of 2/4 or 0.5, since two of the four silanol groups are modified, while the total carbon number (B) of the alkyl groups is 4, since four methyl groups are added, and A×B=2.

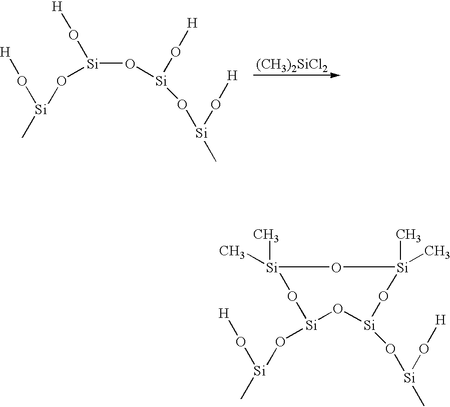

According to the present invention, silica has a modification factor (A×B) of 0.45 to 8, preferably 0.45 to 4, and more preferably 0.5 to 2. The hydrophobic treatment of the silanol groups in silica with alkyl groups improves its affinity for the matrix resin. If its modification factor falls within the range as stated, silica is uniformly dispersed in the matrix resin owing to its high affinity therefor and gives a transparent resin of high strength and low thermal expansibility without lowering its transparency. The remaining silanol groups (—Si—OH) form a hydrogen bond with the functional groups in the matrix resin, for example, the carbonyl groups (—C═O) in the skeleton if the matrix resin is polymethyl methacrylate, whereby a transparent resin composition of still higher strength is obtained.

In order to produce such a modified silica composition, finely particulate silica having silanol groups is treated with any of various silicone compounds including silanes, silazanes and siloxanes.

As regards finely particulate silica, any inorganic silica having silanol groups (—Si—OH) can be used. The hydrogen atom at the end of the silanol group has the property of an active proton and reacts with an alkali actively, and forms a hydrogen bond with a functional group containing an atom of high electrical negativity, such as a nitrogen or fluorine atom, or an oxygen atom in a carbonyl group. Therefore, the modified silica composition is thoroughly mixed in the matrix resin. Finely particulate silica may be formed from a commercially available product obtained by the high temperature hydrolysis of silicon tetrachloride (SiCl₄) or the hydrolysis of sodium silicate [(SiO₂)ₙ—Na₂O]. The former is sold in the form of a fine powder, and the latter in the form of a colloid dispersible in water or an organic solvent, and both can be used as the raw material for the modified silica composition according to the present invention. Finely particulate silica preferably has an average primary particle diameter not exceeding 380 nm (viz., nanometer), and more preferably of 5 to 50 nm. Its addition to a transparent resin gives a resin of high transparency.

Any of the compounds shown below is preferred as an agent for modifying finely particulate silica:

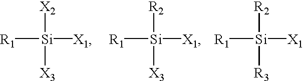

(wherein R₁, R₂ and R₃ stand, independently of one another, for an alkyl group having 1 to 20 carbon atoms and optionally having a branch, and X₁, X₂ and X₃ stand, independently of one another, for a chlorine atom, a hydrogen atom, or an alkoxy group having 1 to 8 carbon atoms.)

The alkyl group having 1 to 20 carbon groups may be a methyl, ethyl, propyl, isopropyl, butyl, isobutyl, sec-butyl, tert-butyl, pentyl, ispentyl, neopentyl, hexyl, heptyl, octyl, decyl, dodecyl or octadecyl group, and the alkoxy group having 1 to 8 carbon atoms maybe a, methoxy, ethoxypropoxy, isopropoxy, buthoxy, pentyloxy, hexyloxy, 2-ethylhexyloxy or octyloxy group. The addition of alkyl groups to silica makes it hydrophobic. X₁, X₂ and X₃ may each be a methoxy, ethoxy, propoxy, isopropoxy, buthoxy, isobuthoxy, sec-buthoxy, tert-buthoxy, pentyloxy, hexyloxy, 2-ethylhexyloxy or octyloxy group. X₁, X₂ and X₃ react easily with silanol groups, so that the ratio of modification is easy to control.

Referring more specifically to silicone compounds for modifying finely particulate silica, examples of silicone compounds having one alkyl group are n-butyltrichlorosilane, n-butyltrimethoxysilane, n-decyltrichlorosilane, n-decyltriethoxysilane, dimethoxymethylchlorosilane, n-dodecyltrichlorosilane, n-dodecyltriethoxysilane, ethyltrichlorosilane, ethyltriethoxysilane, ethyltrimethoxysilane, n-heptyltrichlorosilane, n-hexadecyltrichlorosilane, n-hexadecyltrimethoxysilane, n-hexyltrichlorosilane, n-hexyltriethoxysilane, n-hexyltrimethoxysilane, methyltrichlorosilane, methyltriethoxysilane, n-octadecyltrichlorosilane, n-octadecyltriethoxysilane, n-octadecyltrimethoxysilane, n-propyltrichlorosolane, n-propyltriethoxysilane and n-propyltrimethoxysilane.

Examples of silicone compounds having two alkyl groups are n-butylmethyldichlorosilane, n-decylmethyldichlorosilane, di-n-butyldichlorosilane, diethyldichlorosilane, diethyldiethoxysilane, di-n-hexyldichlorosilane, dimethyldichlorosilane, dimethyldiethoxysilane, dimethyldimethoxysilane, dimethyldipropoxysilane, dimethylmethoxychlorosilane, di-n-octyldichlorosilane, docosylmethyldichlorosilane, dodecylmethyldichlorosilane, dodecylmethyldiethoxysilane, ethylmethyldichlorosilane, n-heptylmethyldichlorosilane, n-hexylmethyldichlorosilane, methylpentyldichlorosilane, n-octadecylmethoxydichlorosilane, n-octadecylmethyldichlorosilane and propylmethyldichlorosilane.

Examples of silicone compounds containing three alkyl groups are n-decyldimethylchlorosilane, ethyldimethylchlorosilane, n-octadecyldimethylchlorosilane, n-octadecyldimethylmethoxysilane, n-octyldimethylchlorosilane, n-propyldimethylchlorosilane, trimethylchlorosilane, trimethylethoxysilane, trimethylmethoxysilane, trimethyl-n-propoxysilane and tri-n-propylchlorosilane.

Owing to the hydrophobicity of the alkyl groups which it contains, any of such silicone compounds give a modified silica composition having a high level of compatibility with an organic resin and an improved affinity for, among others, a (meth)acrylic, polycarbonate or polystyrene resin. Its improved affinity for the matrix resin enables silica to be uniformly dispersed in the matrix resin.

The modified silica composition of the present invention is not particularly limited in particle shape, but may not only be in a common or substantially spherical shape, but also be in the form of a rectangular parallelepiped, a straight linear shape, or a branched shape. Irrespective of their shape, however, the average of the lengths of the longest portions as measured along a straight line of the particles of the modified silica composition (hereinafter referred to as its average primary particle diameter) is preferably not over 380 nm, or the wavelength of visible light, and more preferably from 5 to 50 nm. The range not exceeding 380 nm ensures the transparency of the resin composition containing the modified silica composition. The range of 5 to 50 nm is particularly preferred for transparency.

The modified silica composition of the present invention can be prepared by the process which will now be described. According to a second aspect of the present invention, therefore, there is provided a method for producing a modified silica composition characterized by modifying finely particulate silica with a silicone compound as shown by formulas above.

The modification of finely particulate silica with a silicone compound can be carried out by a liquid-phase process which includes dispersing a silica powder in a solvent such as cyclohexane, adding a silicone compound as a modifying agent, and giving treatment under reflux. Then, the reaction product is washed in cyclohexane. The solvent in which silica is dispersed may be selected from among paraffin hydrocarbons such as pentane, hexane, heptane and octane; cycloparaffin hydrocarbons such as cyclobutane, cyclopentane and cyclohexane; or aromatic hydrocarbons such as methyl ethyl ketone, toluene, xylene, acetone and benzene. Silica is dispersed in the solvent so that it may have a concentration of 1 to 30 weight percent (wt. %). The modification factor is variable with the kind and concentration of the modifying agent and the reflux time. A preferred reaction temperature is from 40 to 200° C. and a preferred reflux time is at least 0.5 hour. If a modifying agent containing chlorine is employed, it is possible to use a catalyst for the modification reaction to collect any hydrogen chloride occurring from the reaction. Pyridine can be used as the catalyst in the amount of 0 to 300 parts by weight for 100 parts by weight of the modifying agent.

The modification can also be carried out by a vapor-phase process which includes heating a silica powder in a vacuum line to remove any adsorbed water therefrom, introducing vapor of a silicone compound as a modifying agent and heating the whole at a temperature of 200 to 300° C. The modification factor is variable with the modifying agent employed and its amount. If the silica to be modified is in the form of a colloid dispersed in water, it is necessary to replace water with an organic solvent, such as methyl ethyl ketone, to avoid any reaction with water. A method for such replacement is disclosed in Japanese Patent Application Laid-Open No. 2000-44226, etc.

According to a third aspect of the present invention, there is provided a transparent resin composition (C) which comprises a modified silica composition as described above and a transparent resin. In the context of this specification, the transparent resin is a resin having a total light transmittance of at least 75%. Examples of the transparent resins are (meth)acrylic type polymer materials such as polymethyl methacrylate, polycarbonate type polymer materials, polystyrene type polymer materials and polyester type polymer materials such as polyethylene terephthalate, and (meth)acrylic, polycarbonate and polystyrene type materials are preferred as resins of higher transparency. (Meth)acrylic type polymer materials containing methyl methacrylate having carbonyl groups (—C═O) or the polycarbonate type materials are preferred in view of the interaction between the silanol groups in the modified silica composition and the functional groups in the matrix resin. (Meth)acrylic type polymer materials are preferred because of their good weatherability for any item of frequent outdoor use, such as the window panes of a motor vehicle. The (meth)acrylic, polycarbonate and polystyrene type polymer materials consist mainly of (meth)acrylic, divalent phenyl, and styrene monomers, respectively, and are more particularly polymer materials consisting mainly of methacrylic monomers, (meth)acrylic monomers, diphenyl carbonate and bisphenol A, respectively. The transparent resin composition (C) of the present invention has a modified silica composition dispersed in a transparent resin, and the silanol groups in the modified silica composition and the functional groups in the transparent resin form hydrogen bonds which make it possible to improve the interfacial action between the resin and fine silica composition and thereby obtain a transparent resin composition (C) of high transparency.

The transparent resin composition (C) of the present invention preferably contains 1 to 80 parts, and more preferably 3 to 40 parts, by weight of the modified silica composition with 100 parts by weight of the transparent resin. The specifically limited range of the modified silica composition makes it possible to ensure rigidity and impact strength, as well as transparency. With an increase in proportion of the modified silica composition, the transparent resin composition (C) has a higher strength and a lower thermal expansibility, but at any proportion over 80 parts by weight, hardly any better result can be expected, but it is likely that the composition (C) may have a lower transparency and a higher specific gravity giving an increased weight to any product. At any proportion below 1 part by weight, the modified silica composition is not very effective for lowering the thermal expansibility of the transparent resin composition, but may fail to improve its strength. The improved strength of the transparent resin composition can be observed if the modified silica composition has a proportion of at least 3 parts by weight, and if it is below 40 parts by weight, it is possible to attain all of the functions as intended and minimize any increase in weight. Thus, it is preferable for the modified silica composition to have a proportion of 3 to 40 parts by weight for 100 parts by weight of the transparent resin.

The transparent resin composition (C) of the present invention can be produced if a transparent resin is dissolved in a solvent and if its solution is mixed with a solution of a modified silica composition, though there is no particular limitation. According to a fourth aspect of the present invention, therefore, there is provided a method for producing a transparent resin composition (C), characterized by mixing a solution of a modified silica composition and a solution of a transparent resin.

The solvent for dissolving the modified silica composition may be selected from among, for example, paraffin hydrocarbons such as pentane, hexane, heptane and octane; cycloparaffin hydrocarbons such as cyclobutane, cyclopentane and cyclohexane; and aromatic hydrocarbons such as methyl ethyl ketone, toluene, xylene, acetone and benzene. The concentration of the modified silica composition in its solution is not particularly limited, but from the standpoints of uniform mixing and easy work, it is preferably not higher than 20% by weight.

The solvent for preparing a solution of the transparent resin depends upon the resin to be dissolved, and, for example, an aromatic or ketone type organic solvent, such as acetone, aniline, xylene, ethyl acetate, methyl acetate, butyl acetate, toluene or methyl ethyl ketone, is preferably employed for a (meth) acrylic polymer material containing methyl methacrylate, etc. as a principal monomer. According to the present invention, the transparent resin composition (C) can be produced by kneading the solution of the transparent resin and the modified silica composition and removing the solvent. Alcohol, such as ethanol, methanol or butanol, can be used as a solvent for solidification in the proportion of 10 to 300 parts, and preferably 50 to 100 parts, by weight for 100 parts by weight of the transparent resin solution.

The transparent resin composition (C) of the present invention may further contain any of various additives, such as an antistatic agent, an oxidation inhibitor, a heat stabilizer, an ultraviolet absorber, a flame retardant, a pigment and a coloring agent, if they are required without lowering the transparency of the composition.

According to a fifth aspect of the present invention, there is provided a thermoplastic resin laminate comprising at least one layer of each of a transparent resin composition (C) as described above and a thermoplastic resin (D), the composition (C) and the resin (D) forming alternating layers. If the resin layers are bonded together by e.g. an adhesive, the characteristics of the individual layers are damped or absorbed by the adhesive layer, have only a lower effect on any adjoining resin layer and do not extend to the whole laminate. In the laminate of the present invention, however, the resin layers are welded together by heat, the characteristics of the individual layers, such as rigidity, are utilized to cover their drawbacks, such as thermal deformation, to improve the rigidity of the laminate, so that it may be possible to restrain in the whole laminate any warpage caused by the relaxation of any residual stress in the layers at a high temperature.

A combination of layers containing different proportions of the modified silica composition in the transparent resin composition (C) gives a laminate having a wide variety of characteristics. For example, a laminate has a high scratch resistance if its outermost layer contains a high proportion of the modified silica composition. If both of its uppermost and lowermost layers contain a high proportion of the modified silica composition, the laminate is of high rigidity and its upper and lower layers produce a binding force to restrain any thermal deformation by any residual stress at a high temperature. If its middle layer contains a high proportion of the modified silica composition, the laminate is of high rigidity and exhibits a greater force for restraining thermal deformation. If its upper layer contains a high proportion of the modified silica composition, while its lower layer contains a low proportion thereof, so that it may contain a varying proportion of the modified silica composition, the laminate has a varying distribution of rigidity which makes it possible to control the direction of any warpage caused by thermal deformation, though it may alternatively possible for the upper layer to contain a lower proportion of the modified silica composition. Thus, as the laminate is made by the heat welding of the transparent resin composition (C) and the thermoplastic resin (D), it is possible to rely upon the characteristics of the individual layers for raising the elastic modulus of the laminate and improving its impact strength and rigidity, and if its outermost layer, or any adjoining layer contains a high proportion of silica, the laminate has a high scratch resistance, while the formation of layers producing a binding force makes it possible to restrain any thermal deformation, overcome any surface roughening by warpage or deformation and improve the quality of its surface appearance. Moreover, the modified silica composition suppresses the thermal expansion of the resin layers and of the laminate as a whole. If the resin layers are not welded, but are bonded together by e.g. an adhesive, the characteristics of the individual layers are damped or absorbed by the adhesive layer, have only a lower effect on any adjoining resin layer and do not extend to the whole laminate.

The laminate may contain the modified silica composition in every layer, or only in a part of its resin layers, such as its surface or bottom layer. It is preferable for every layer to contain it for the improved rigidity of the laminate. It is also possible to vary its proportion from the upper to the lower layer, depending upon the purpose for which the laminate is intended. In any event, the laminate is of high rigidity, low thermal expansibility and improved scratch resistance and resists any warpage even at a high temperature if it is a thermoplastic resin laminate comprising at least one layer of each of the transparent resin composition (C) and the thermoplastic resin (D), the transparent resin composition (C) and the thermoplastic resin (D) forming alternating layers.

The thermoplastic resin (D) may be a polycarbonate resin, a styrene resin, poly-4-methylpentene-1, a thermoplastic polyurethane resin, etc., though a polycarbonate resin is, among others, preferred. The polycarbonate resin is a polymer derived from a divalent phenol compound, such as bisphenol A, and may be produced by a phosgene process, ester interchange, or solid-phase polymerization. It may not only be a known polycarbonate resin, but may also be a polycarbonate resin produced by polymerization in an ester interchange process.

The laminate has a thickness of 0.5 to 10 mm, and preferably 1 to 5 mm. With a thickness below 0.5 mm, the laminate may fail to retain its shape even if it may contain a higher proportion of silica. With a thickness over 10 mm, the laminate may not have its middle layer bound effectively, but may be warped at a high temperature and present a poor- appearance. The resin layers in the laminate may each be of any suitable thickness selected from within the range stated above in accordance with the use for which it is intended, and the properties which it is required to have.

The laminate of the present invention is preferably manufactured by molding under heat or pressure, though there is no particular limitation. According to a sixth aspect of the present invention, therefore, there is provided a method for producing a laminate by molding under heat and/or pressure.

For example, a first method employs an extruder suited for the transparent resin composition (C) and the thermoplastic resin (D), and comprises co-extruding molten resins into sheets through a T-die having a number of slits depending upon the number of layers to be formed, and welding every two adjoining resin layers together under heat. The extruder and T-die are held at substantially the same temperature, and though each sheet of the resin (D) or the transparent resin composition (C) may have a very thin solidified film formed on its surface when all the sheets meet to form a laminate, the sheets have their surfaces melted again by the internal heat of the resin and have a mixed layer formed between every two joining surfaces by the diffusion of the composition (C) and the resin (D), so that the laminate may have its layers bonded together firmly.

According to a second method, single-layer sheets of the transparent resin composition (C) and the resin (D), or a laminate as made by the first method is heated in a press having a heating plate, and is compression molded to form a laminate. The laminate of the present invention can be made by compression molding a plurality of single-layer sheets together. According to the second method, it is preferable to insert are movable panel heater between every two adjoining surfaces, heat those surfaces into a molten state and remove the heater before compression molding.

A third method employs a two-color injection molding machine having a mold movable back and forth to define a cavity having a variable volume, and comprises injection molding a single-layer sheet of the transparent resin composition (C), retracting the mold immediately, and during or immediately after the retraction of the mold, injecting the resin (D) into an empty cavity formed by its retraction. Although the transparent resin composition (C) may have a very thin solidified film formed on its surface, the heat of the resin (D) injected thereon to melts the film again and the diffusion of the transparent resin composition (C) and the resin (D) forms a mixed layer defining a strong joining surface therebetween. These steps are repeated to form a laminate having any desired laminated structure. If the mold temperature and the injection temperature of the resin are set 20 to 50° C. higher than for any ordinary injection molding, the laminate has its layers welded together. A method which is suitable for the size of the laminate to be made, the number of layers to be formed, etc. may be selected from the methods as described.

The transparent resin composition (C) and the resin (D) forming the laminate may further contain various additives, such as an antistatic agent, an oxidation inhibitor, a heat stabilizer, an ultraviolet absorber, and a flame retardant, if they are required to make a laminate having their properties without lowering its transparency, and it is possible to make a laminate having a colored layer and a transparent layer if its lower layer is formed as a colored layer containing a pigment, or coloring agent, and is laminated with a transparent layer.

According to a seventh aspect of the present invention, there are provided a molded product of the resin composition, or thermoplastic resin laminate as described above for a part of the interior or exterior decoration of a motor vehicle, an outer plate for the vehicle and a resin windowpane for the vehicle.

The resin composition or laminate of the present invention is suitable for making a part of the exterior decoration of a motor vehicle or its outer plate owing to its high transparency and rigidity, and its substantial freedom from any warpage even at a high temperature.

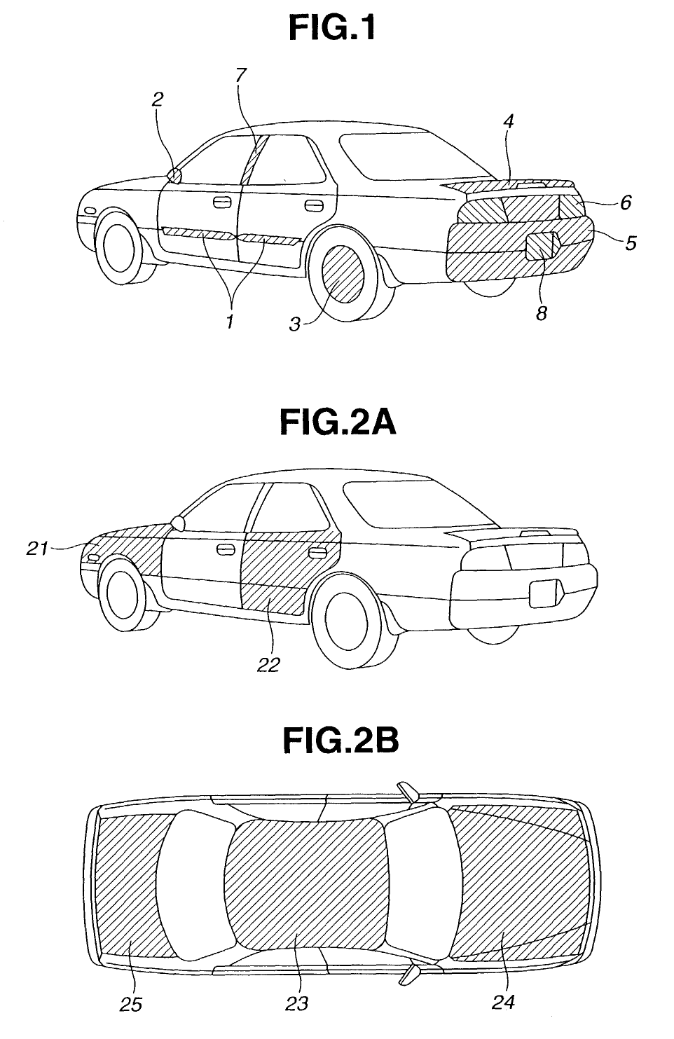

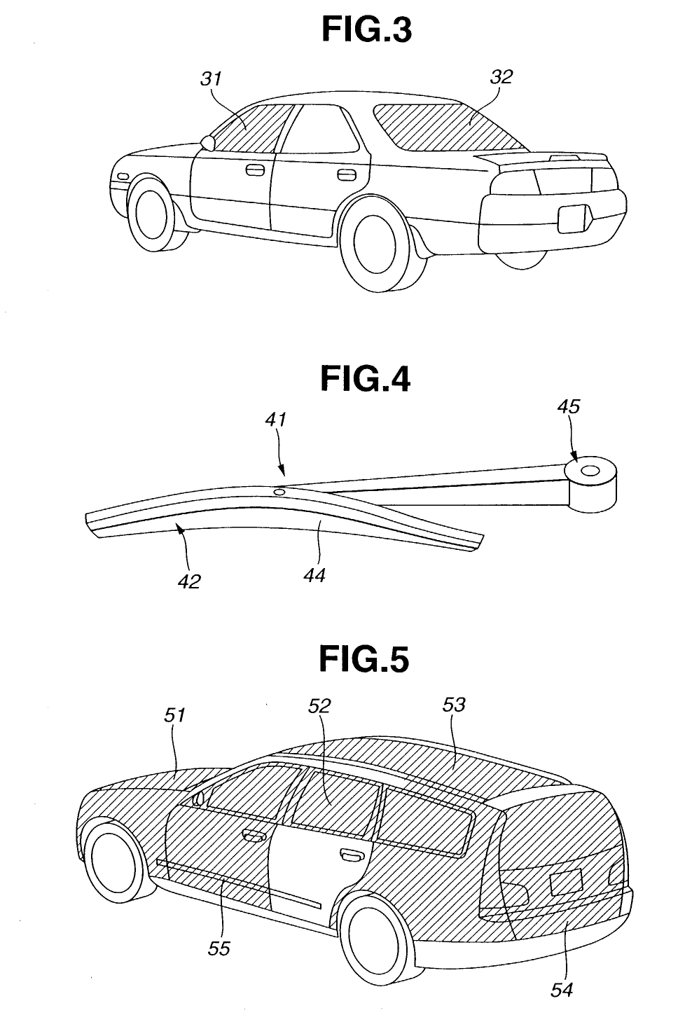

For example, FIG. 1 shows molded parts forming the exterior decoration of a motor vehicle, including door moldings 1, frames 2 for door mirrors, wheel caps 3, a spoiler 4, bumpers 5, winker lenses 6, pillar garnishes 7, a rear finisher 8 and headlamp covers (not shown), and FIGS. 2A and 2B show outer plate members for the motor vehicle, including front fenders 21, door panels 22, a roof panel 23, a hood panel 24, a trunk lid 25 and back door panels (not shown). It is also applicable to a front window pane (not shown), side window panes 31 and a rear window pane 32, as shown in FIG. 3.

According to the present invention, it is possible to mix a coloring agent, such as a pigment, in the transparent resin composition (C) or incorporate a colored layer in the laminate to make a product having any desired color tone, as stated above. The laminate of the present invention may be a transparent one not containing any colored layer, or a laminate composed of transparent and colored layers. Therefore, it is useful for not only a motor vehicle as explained above, but also for any other application calling for an appearance of high quality including pleasantness, smoothness and clarity, as well as high rigidity and scratch resistance, such as the preparation of any part forming the exterior or interior decoration of a building, or the interior decoration of a railroad car.

Any such product including a part for a vehicle, or a part forming the interior decoration of a building can be manufactured by any suitable method, such as injection molding, or vacuum or pressure molding, depending upon the product to be made. Although a common glass fiber-reinforced resin undergoes a gradual lowering in physical properties and is lowly recyclable, because of the destruction of glass fiber subjected repeatedly to shearing stress, the transparent resin composition (C) of the present invention has only a limited degree of lowering in physical properties owing to the modified silica composition which makes it hardly susceptible to any shearing stress.

The laminate of the present invention can also be shaped by a known resin molding method, such as vacuum forming, vacuum and pressure forming, hot compression molding or blow molding, to make resin glass, a part forming the exterior decoration of a motor vehicle, such as an outer plate, or a part forming its interior decoration. It is also possible to make a molded product forming a part of the interior or exterior decoration of a motor vehicle by injection or compression molding if the laminate is placed in a mold and if a resin is fed into the mold to form a unitary product with the outer periphery of the laminate. Unitary molding enables any intended product to be made without calling for any complicated method.

According to an eighth aspect of the present invention, there are provided a resinous wiper system, a resinous door mirror stay and a resinous pillar each comprising the resin composition as described above. The resin composition of the present invention is suitable for use in making any item required to ensure an improved visibility therethrough, such as a wiper system, or pillar, owing to its high rigidity, heat resistance, dimensional stability after heating or molding, and transparency.

A known wiper system has been made of steel having a black finish coating and black rubber, and has often lowered driver's visibility when the vehicle moves at a lower speed. Known door mirror stays have been formed from a resin having a finish coating in the same color with the outer plate, or a black color, and have often lowered driver's visibility during a right or left turn of the vehicle. Known pillars have been of steel, and the front and center pillars have often lowered driver's visibility when the vehicle is under running, or makes a right or left turn, and the rear pillars when the vehicle moves back, or when the driver checks to ensure safety behind the vehicle. Although the use of a transparent resinous material for any such item improves visibility, it has been difficult to satisfy high rigidity, heat resistance and dimensional stability after heating or molding with any traditional transparent resinous material. The resin composition of the present invention is a transparent material of high rigidity and low thermal expansibility or contractibility, and its use overcomes the above problems. The transparency of any such part contributes not only to its improved visibility, but also to its improved ornamental quality.

FIG. 4 is a diagram showing a wiper system by way of example. It has a wiper arm 41 and a wiper blade 42, and is movable along a half arc about a nut hole 45 for securing the wiper arm. Wiper blade 42 is usually composed of an elastic supporting portion 43 and a soft rubber portion 44, and the resin composition of the present invention is used as a transparent material for at least one of the wiper arm, wiper blade and wiper blade supporting portion in a wiper system according to the present invention. It is preferable to use, for example, silicone rubber having high durability and a relatively high transparency for the rubber portion in the wiper system of the present invention. A resin composition obtained by adding an adequate amount of acrylic rubber to the resin composition of the present invention may be used for making the wiper blade supporting portion. It imparts an adequate elasticity to the wiper blade supporting portion. Such a resin composition is obtained by, for example, adding 1 to 30 parts by weight of acrylic rubber (ethyl or butyl acrylate, or a copolymer thereof, e.g. NipolAR31 of Nippon Zeon Co. Ltd.) to 100 parts by weight of the resin composition of the present invention.

The door mirror stay or resinous pillar of the present invention is not only a door mirror stay, or pillar molded from the resin composition of the present invention as a transparent material, but may also be composed of a multi-layer laminate formed by laminating the resin composition of the present invention with another resin. Such a laminate has at least one layer formed from the resin composition of the present invention, and preferably has its outermost and lowermost layers, and more preferably a middle layer, too, formed from the resin composition of the present invention. The multi-layer laminate has additional functions other than those given by the resin composition of the present invention. The thickness of each individual layer in the laminate may be so selected as to suit the thickness of a final product and the number of the layers. A polycarbonate, polystyrene, or styrene-methyl methacrylate copolymer resin may be used as another resin for foring such a laminate. The thermoplastic resin laminate of the present invention can also be used as the multi-layer laminate. There is no particular limitation in a method for producing a door mirror stay, or resinous pillar by using the resin composition of the present invention or the multi-layer laminate as described. While it is possible to make a door mirror stay, or pillar as a discrete item, it is also possible to make it as a part of an integrally molded combination, such as a combination of a door mirror stay and a front pillar, or of a pillar and a resinous roof panel, by a method to be described later, if it is useful as a door mirror stay, or pillar.

According to a ninth aspect of the present invention, there is provided a molded resin product having a transparent portion and an opaque portion, at least the transparent portion containing the resin composition as described above. The resin composition of the present invention is suitable for use in making an integrally molded resin product having a transparent portion and an opaque portion, owing to its high rigidity, heat resistance, dimensional stability after heating or molding, chemical resistance and transparency. The molded resin products will be described by reference to parts for a motor vehicle.

A motor vehicle contains a mixture of transparent parts, such as lamps, covers and panes, and opaque parts, such as outer panels and parts of interior decoration. It has been difficult to form a unitary combination of transparent and opaque parts from any traditional resinous material, since those parts are required to exhibit different properties including transparency, rigidity, heat resistance, low linear expansibility, low molding contractibility and chemical resistance. The resin composition of the present invention is, however, easy to use for injection molding, or vacuum or pressure molding, and can be used as a transparent material for making an integrally molded combination of transparent and opaque portions, while ensuring high rigidity, high heat resistance, low linear expansibility, low molding contractibility and high chemical resistance, to thereby reduce the numbers of parts and process steps and decrease the weight of parts. The integral molding of transparent and opaque portions combines the traditionally divided contour lines of any part into a single continuous line and thereby improves its outward appearance. More specifically, head lamps of which transparency is required are surrounded by other opaque parts, such as a bumper, a front grill, a fender and a hood. Their integral molding makes it possible to reduce the number of parts and thereby the number of steps in an assembly process. The resin composition of the present invention is so high in heat resistance that there is no fear of the resin being melted by a nearby source of heat in a lamp. A traditional headlamp formed from a polycarbonate resin has called for a surface coating, since it is so low in light resistance-as to undergo yellowing by exposure to sunlight. Such a problem can be overcome by using the resin composition of the present invention.

There is no particular limitation in a method for producing such a molded resin product. Glass parts for a motor vehicle are examples of parts of which transparency is required, and they are known as side and back door panes attached to the doors, rear quarter panes attached to the rear fenders and roof, and rear panes. The side or back door pane is of the construction having a sheet of glass disposed between the door outer and inner. It is possible to mold an integral combination of door outer and inner and glass by defining a hollow cavity between the door outer and inner, and pouring the resin composition of the present invention into the cavity. It is possible to make an integral combination of a pillar garnish and a rear quarter pane in a similar way.

Molded resin products according to the present invention are shown in FIG. 5, and include not only an integral resin molded combination of pillar garnish and rear quarter pane as mentioned, but also an integral resin molded combination 51 of lamp, hood and fender, an integral resin molded combination 52 of pillar garnish and pane, an integral resin molded combination 53 of roof, fender and pane, an integral resin molded combination 54 of back door and pane and an integral resin molded combination 55 of door and pane. Door locks, a wiper motor, etc. may be installed in the hollows of the relevant parts later.

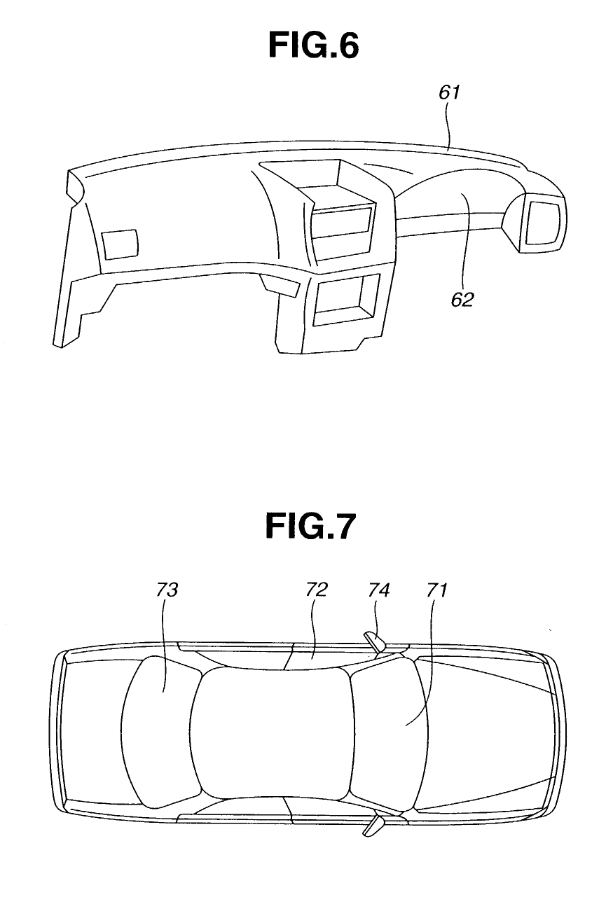

As regards an instrument panel in a motor vehicle, such as one shown in FIG. 6, it has been usual to prepare instruments, a transparent cover therefore and a cluster lid as separate parts. If an integral combination of transparent and opaque resin portions is molded by using the resin composition of the present invention, it is possible to prepare an integral assembly of an instrument panel 61 and an instrument cover 62 and combine several kinds of parts into the instrument panel to thereby reduce the number of parts and achieve a weight reduction.

The resin composition of the present invention can also be used to make a molded resin product of high strength and rigidity having a transparent portion and an opaque portion.

For example, the resin composition of the present invention can be used to make a transparent roof portion without providing a glass sunroof. The opaque portion of any such molded product may or may not be colored.

The molded resin product of the present invention having a transparent portion and a colored opaque portion may be made by, for example, using a colored resin, painting or printing a color on the opaque portion, or employing a colored sheet of an opaque resin.

A colored resin may be prepared by dispersing a pigment in a resin, or by kneading a molten mixture of resin and pigment pellets and injecting it into a mold in an injection molding machine. Such a colored resin may be used to make a molded resin product according to the present invention by opening the mold or forming a new molten resin passage, and injecting a molten transparent resin into the mold cavity through a separate cylinder. Thus, it is possible to make a molded resin product having a transparent portion and a colored opaque portion. Either a transparent resin or an opaque resin may be injected first.

An opaque portion colored by painting or printing may be formed by molding an intended resin product from a molten transparent resin and painting or printing the front or rear side of the molded product to color it and make it opaque. It is alternatively possible to paint or print a color before shaping a molten resin.

A colored sheet of an opaque resin may be used to make a molded resin product according to the present invention by shaping a colored opaque resin sheet preliminarily, placing it in a mold, injecting a molten transparent resin into the mold, cooling the resin to solidify it and removing the whole from the mold.

The method described above makes it possible to produce, for example, an integral resin molded combination of roof, fender and pane not only in such a way that the pane is transparent, while the roof and fender are opaque, but also in such a way that an upper portion of the pane and a portion of the roof are transparent, while the fender and the remaining portions of the pane and roof are opaque.

Although the molded resin product having an integral combination of transparent and opaque portions according to the present invention can be formed from the resin composition of the present invention and a pigment, it may also be composed of a multi-layer laminate formed by laminating the resin composition of the present invention with another resin. Such a laminate has at least one layer formed from the resin composition of the present invention, and preferably has its outermost and lowermost layers, and more preferably a middle layer, too, formed from the resin composition of the present invention. The multi-layer laminate provides additional functions not achieved by the resin composition of the present invention alone. The other resin forming the multi-layer laminate and the thickness of each layer may be so selected as to suit the purpose for which the molded resin product is intended.

According to a tenth aspect of the present invention, there are provided a resinous window pane with heat rays, a resinous mirror, a resinous lamp reflector, a resinous cover or case in an engine compartment, and a resinous part for a cooler.

The resin composition of the present invention is suitable for use in making parts, such as a window pane, a mirror, a lamp reflector, or a cover or case in an engine compartment, owing to its high rigidity, high heat resistance, dimensional stability after heating or molding, chemical resistance and transparency, and makes it possible to achieve a reduction in the numbers of parts and process steps and weight. The resin composition of the present invention can be used as a transparent material to replace the material for any part required to be clear, so that its clouding may be prevented for improved visibility. For example, a resinous window pane, such as a front window pane 71, a door window pane 72 or a rear window pane 73 as shown in FIG. 7, is often provided in its molded product or on its surface with a heat-ray heater for heating it to prevent its clouding. Although a traditional transparent resinous material has presented problems of heat resistance and thermal expansion in the presence of heat by a heat-ray heater, no such problem occurs from the use of the resin composition according to the present invention. Owing to its high rigidity, the resin composition of the present invention is applicable to a large item, such as front window pane 71, door window pane 72 or rear window pane 73, to reduce its weight. A heat-ray heater may be formed by, for example, insert molding a heat-ray device prepared in film form, or forming a heat-ray device on the inner surface of the window pane by vapor deposition, coating or printing. The transparent resin of the present invention can also be used to make a side mirror 74 (see FIG. 7) which is lighter in weight than one of any traditional glass or transparent resin, and which can be equipped with a heat-ray heater to avoid clouding. It is also applicable to a room mirror.

FIG. 8 is a cross sectional view of a head lamp unit for a motor vehicle. A reflector 83 is mounted in an outer member 82 secured to a base 81 on the vehicle body, and a bulb 84 and an optical axis regulator 85 are connected to the reflector, while an outer lens 86 is fitted on the outer member. Although a reflector formed from any traditional resinous material has often been inferior in heat resistance, linear expansibility and linear expansion anisotropy, the use of the resin composition according to the present invention overcomes those problems. Owing to its high rigidity, the resin composition of the present invention makes a lamp reflector which is light in weight and high in heat resistance, as well as in dimensional stability and surface smoothness, and which is suitable as a reflector for a head, fog, or rear combination lamp, or a sub-reflector for a head lamp. Its reflecting portion may be formed by, for example, insert molding a reflecting film during the manufacture of the member, or forming a reflecting film by vapor deposition after injection or press molding the member.

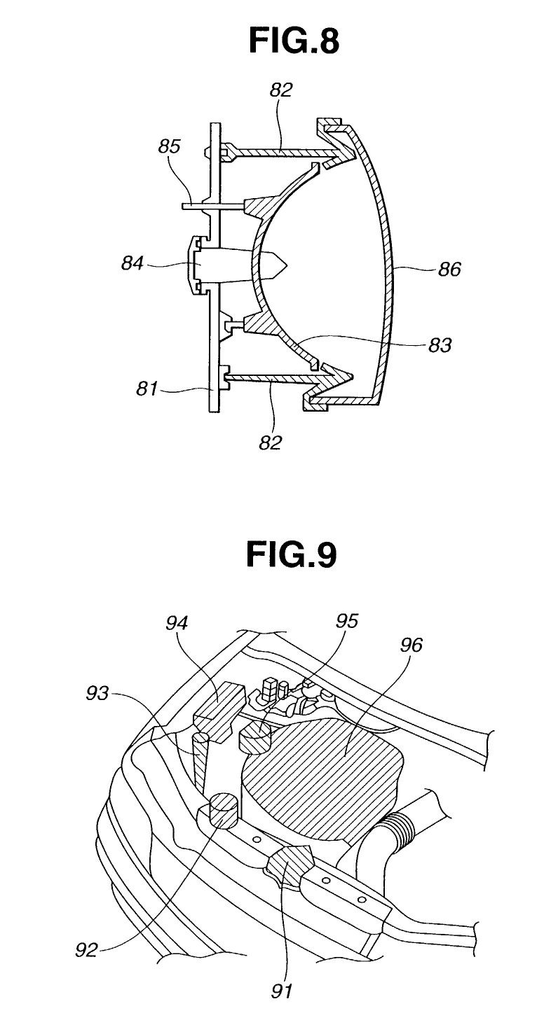

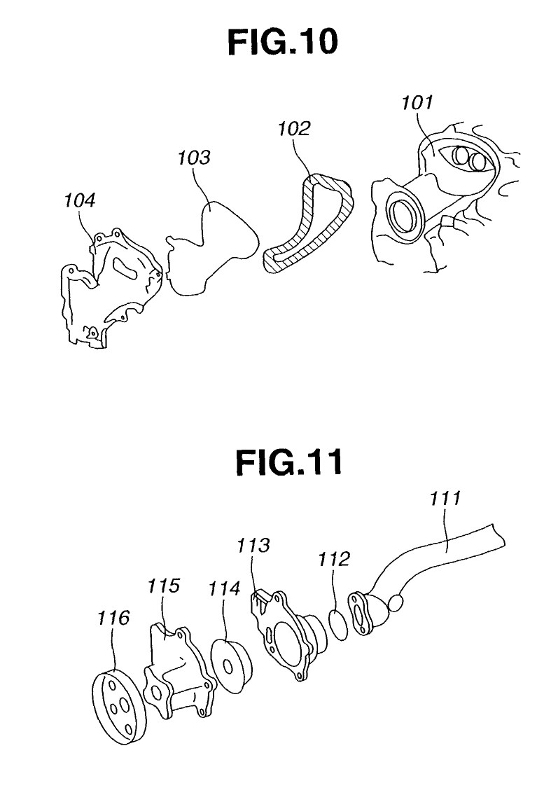

The resin composition of the present invention is also applicable to covers or cases in an engine compartment. The inside of an engine compartment is shown in FIGS. 9 and 10. Owing to its high transparency, heat resistance, chemical resistance and rigidity, the resin composition of the present invention can make various parts of light weight which can withstand use in an engine compartment having severe temperature conditions. Examples of such parts are a radiator 91, a coolant reservoir tank 92, a washer tank inlet 93, a housing 94 for electrical parts, a brake oil tank 95, a cylinder head cover 96, an engine body 101, a timing chain 102, a gasket 103 and a front chain case 104. Owing to its transparency, the resin composition of the present invention improves the visibility of the inside of a tank or cover, such as the washer tank inlet, housing for electrical parts, brake oil tank, cylinder head cover, or timing belt cover.

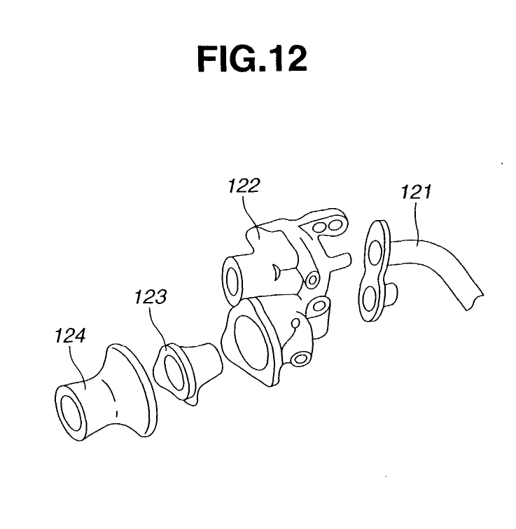

The resin composition of the present invention can make parts of light weight and high heat and chemical resistance and rigidity which are suitable as parts used in contact with cooling water in an engine compartment for a motor vehicle. Such resinous parts for a cooler are shown in FIGS. 11 and 12. They are parts for the top and base of a radiator tank and valves, such as a water pipe 111, an O-ring 112, a water pump housing 113, a water pump impeller 114, a water pump 115 and a water pump pulley 116 which are shown in FIG. 11, and a water pipe 121, a thermostat housing 122, a thermostat 123 and a water inlet 124. The resin composition is of high value in practical use owing to a weight reduction, an improved chemical resistance and an improved fuel consumption.

Although every part described above can be formed from the resin composition of the present invention alone, it may also be composed of a multi-layer laminate formed by laminating the resin composition of the present invention with another resin. Such a laminate has at least one layer formed from the resin composition of the present invention, and preferably has its outermost and lowermost layers, and more preferably a middle layer, too, formed from the resin composition of the present invention. The multi-layer laminate provides additional functions not achieved by the resin composition of the present invention alone. The other resin forming the laminate and the thickness of each layer may be so selected as to suit the purpose for which each part is intended.

According to an eleventh aspect of the present invention, there is provided an integrally molded resin product comprising the resin composition as described above and having a hollow structure communicating with the open air and/or a closed hollow structure. Owing to its high rigidity, heat resistance and dimensional stability after heating or molding as stated, the resin composition of the present invention is suitable for any part having a hollow structure, such as a door, roof or hood. Many of the parts forming the interior and exterior of a motor vehicle have a hollow structure defined by steel plates and resin panels for accommodating an auxiliary device, etc. For example, a side or back door has a hollow structure formed by an outer and an inner steel plate, and has a resin panel attached to the inner steel plate during an assembly process after painting, while an auxiliary devices or devices are installed in the hollow structure. A roof, hood, trunk lid, or back door has an outer plate and are inforcement formed from steel plates, and a resinous part attached to its inside after painting. All of these parts having a hollow structure have been difficult to mold as unitary products from any traditional resinous material, since they are large and have to be of high rigidity and dimensional stability. The resin composition of the present invention having high rigidity, low thermal expansibility and low thermal contractibility, however, enables the molding of any such part as a unitary product and thereby makes it possible to achieve a reduction in the number of the parts, the number of process steps and the weight of the parts.

Although the integrally molded resin product of the present invention can be formed from the resin composition of the present invention alone, it may also be composed of a multi-layer laminate formed by laminating the resin composition of the present invention with another resin. Such a laminate has at least one layer formed from the resin composition of the present invention, and preferably has its outermost and lowermost layers, and more preferably a middle layer, too, formed from the resin composition of the present invention. The multi-layer laminate provides additional functions not achieved by the resin composition of the present invention alone. The other resin forming the multi-layer laminate and the thickness of each layer may be so selected as to suit the purpose for which each product is intended.

The thermoplastic resin laminate of the present invention can be used as such a multi-layer laminate.

The integrally molded resin product of the present invention has an improved commercial value if a skin, or an ornamental layer as formed by a printed design, is formed on its outermost layer to improve its design, feel and quality. For example, a molded product having a skin formed on its outermost layer by a napped sheet, a sheet having an embossed pattern, a sheet having a pattern formed by laser, or a sheet having a pattern like the grain of wood, is useful as, say, the inner portion of a roof, a pillar garnish, or an instrument panel. A multi-layer laminate as described above may have a printed design layer as its middle layer, and present a lustrous or deep appearance if its surface layer is formed from a transparent material.

The integrally molded resin product of the present invention having a hollow structure has an improved heat-insulating and sound-proofing property if its hollow interior is filled with a gas, liquid or solid, or a mixture thereof. The filling material is preferably a gas, such as nitrogen, argon, carbon dioxide or air, if transparency is required, and if no transparency is required, it is preferable to use not only any gas as mentioned above, but also paraffin or wax which is a liquid at an elevated temperature during filling, and a solid at a normal temperature thereafter. The filling material makes it possible to maintain a comfortable environment in a vehicle by restraining the escape of cool air from the vehicle and the infiltration of heat from outside in summer and the escape of warm air and the infiltration of cold air in winter. The double-wall structure having a hollow space therein damps or absorbs the energy of noise from outside, and ensures a calm environment in the vehicle. If such a structure is applied to a hood, it is possible to reduce any radiant noise and heat coming out from the engine compartment.

The integrally molded product of the present invention having a hollow structure can be made by employing, for example, a common vacuum or pressure forming, injection or blow molding, or press forming process, and for example, the following methods will be suitable.

According to a first method, two resin sheets formed from the resin composition of the present invention are fixed in a holder having a path for introducing a pressurized fluid, and the holder is sealed by a known method to form a closed space between the two sheets. The sheets are heated to at least their deflection temperature under load, and set in an open mold, and the softened sheets are welded together along their edges pressed together by the mold. A pressurized fluid is introduced into the closed space between the two sheets during their welding or thereafter, and during the expansion of the sheets or thereafter, the mold is closed and the pressure of the fluid is maintained until a molded product is cooled to form a hollow structure. The mold preferably has an evacuating hole for evacuating the space between the mold surface and each sheet to bring them into intimate contact with each other. Such evacuation gives a molded product of improved transferability. According to a twelfth aspect of the present invention, therefore, there is provided a method for producing an integrally molded resin product which comprises heating two resin sheets containing the resin composition as described before, placing them in an open mold, introducing a pressurized fluid between the sheets before welding them together along their edges or thereafter, and closing the mold during the expansion of the sheets or thereafter, and maintaining the fluid pressure to form a hollow structure.

According to a second method, a closed mold is retracted to have its cavity enlarged, while it is filled with a molten resin composition according to the present invention, or thereafter, and a pressurized fluid is introduced into the molten resin to form a hollow structure.

According to a third method, one or two resin sheets containing the resin composition of the present invention are inserted along the cavity surface of an open mold, and while a molten resin is fed into the closed mold between the two sheets or behind one and the only sheet, or thereafter, a pressurized fluid is introduced into the molten resin to form a hollow structure, while the volume of the cavity is enlarged. More specifically, one resin sheet formed from the resin composition is inserted along the cavity surface on one side of an open mold, and while a molten resin is fed to fill the cavity behind the sheet, or thereafter, a pressurized fluid is introduced into the molten resin to form a hollow structure, while the mold is retracted to enlarge the volume of the cavity, or two resin sheets are inserted along the cavity surfaces on both sides of a mold, and while a molten resin is fed to fill the cavity between the sheets, a pressurized fluid is introduced into the molten resin to form a hollow structure, while the volume of the cavity is enlarged. The resin to be used to fill may be any resin adhering closely to the sheet or sheets containing the resin composition of the present invention, and preferably having a solubility parameter (SP) close to that of the resin composition of the present invention. It is possible to use as such one or more of the thermoplastic resins (D) employed in the thermoplastic resin laminate as described before.

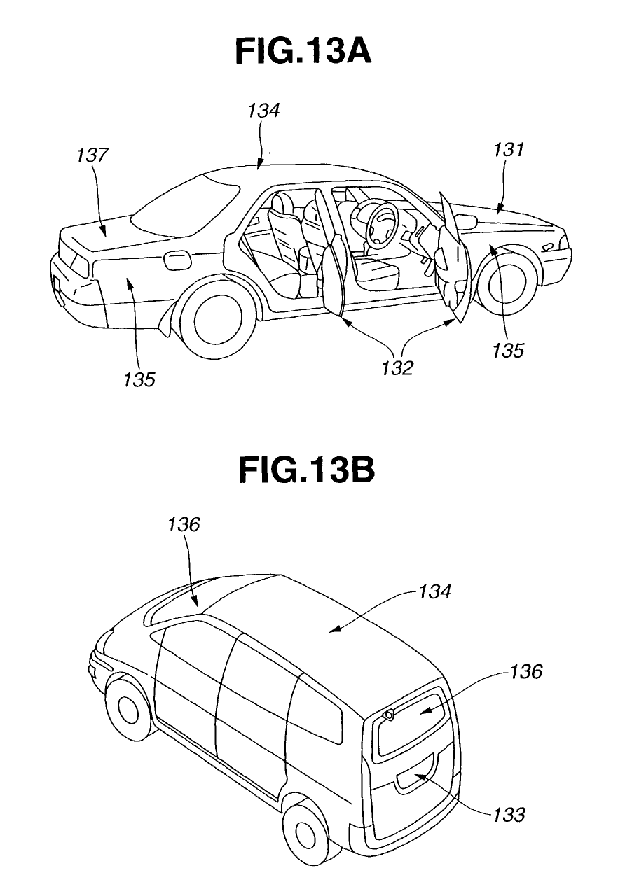

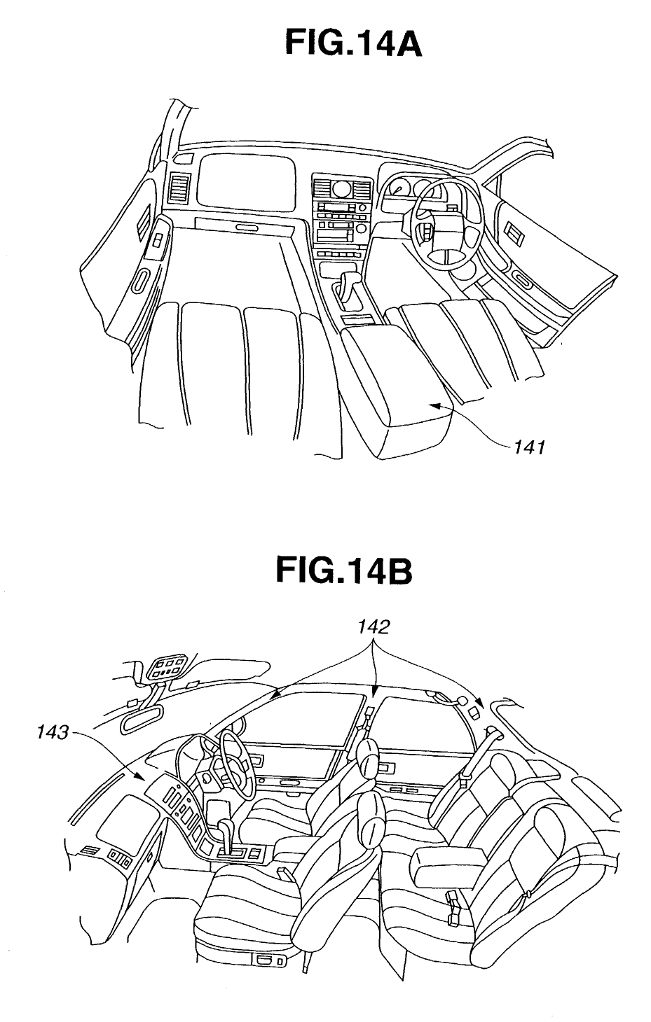

As is seen from FIGS. 13A, 13B, 14A and 14B, the integrally molded resin product of the present invention having a hollow structure is applicable to, for example, a hood 131, a door 132, a back door 133, a roof 134, a fender 135, a window pane 136, a trunk lid 137, a center console box 141, a pillar garnish 142, an instrument panel 143, or a head lining. Any of these parts can be molded with an inner or outer, an auxiliary part, or a reinforcement to make a unitary combination to thereby reduce the number of parts and process steps. Moreover, a hollow part filled with a gas, liquid, or solid, or a mixture thereof can be used to perform additional functions. For example, the hood can be combined with a reinforcement, and can be used to perform sound-proofing and heat-insulating functions, and the roof can be combined with a head lining, and can be used to perform heat-insulating and sound-proofing functions, while each door or fender can be combined with an inner and an outer.

According to a thirteenth aspect of the present invention, there is provided an integrally molded product formed from the resin composition of the present invention and combining two or more kinds of parts having different functions to form a single part having at least two such functions. Examples of the different functions are the function of a display as of an instrument panel, the function of ventilation as of an air conditioner duct, and the function of fixing as of a roof rail. Owing to a broad range of properties including high rigidity, high heat resistance, dimensional stability after heating or molding, and chemical resistance, the resin composition of the present invention is applicable to various parts expected to perform various functions and can be used to make an integrally molded product combining two or more kinds of parts having different functions to form a single part having at least two such functions. It is, therefore, suitable for making a large part in a module, or an integrated form to reduce the number of parts and process steps and the weight of parts, while retaining high quality.

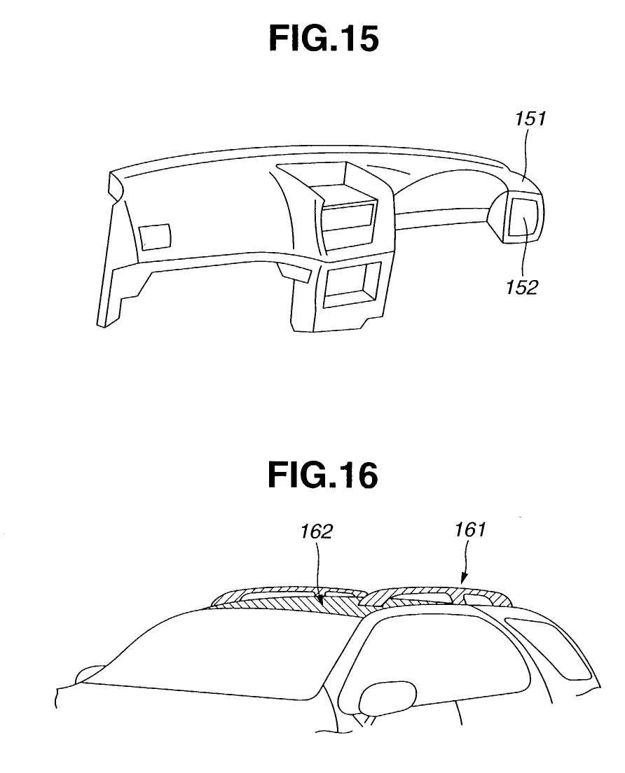

For example, FIG. 15 shows an instrument panel as a large part for the interior of a motor vehicle, and it is usual practice to prepare a panel 151, an air duct and case 152 for an air conditioner and a cross car beam (or steering cross member) separately and put them together in a vehicle manufacturing line. It has been difficult to mold an integral combination of the panel and the air duct and case for an air conditioner from any traditional resinous material, since it results in a large and complex shaped product which is likely to shrink or warp during molding, or expand under heat, but these problems can be overcome if the resin composition of the present invention is used. Owing to its high rigidity, the resin composition of the present invention can combine those parts into a unitary structure, while eliminating any cross car beam (or steering cross member) that has hitherto been made of steel. The resin composition of the present invention can also combine a bracket, or the like that would have had to be prepared separately if it had been made of steel. It also enables a unitary combination including a skin, or like ornamental material to be made by insert molding. Similar results can also be obtained from its application to, for example, a door. A door inner panel is now mainly of steel, and is assembled with various other parts, such as a side window guide rail, a regulator, a door lock and a speaker, in a manufacturing line. The resin composition of the present invention can combine a door inner panel, a guide rail, a speaker housing, etc.

FIG. 16 shows another example of an integrally molded assembly according to the present invention. FIG. 16 shows roof rails 161 as large parts for the exterior of a motor vehicle which are combined with a roof panel 162 formed from the resin composition of the present invention. The roof rails have been difficult to form from any traditional resinous material because of rigidity and heat resistance, since they have to bear a heavy weight and are likely to be exposed to severe temperature conditions. These problems can be overcome by the resin composition of the present invention. Similar results can be obtained from its application to, for example, a spoiler, as a spoiler can be combined with a trunk lid formed from the resin composition of the present invention.

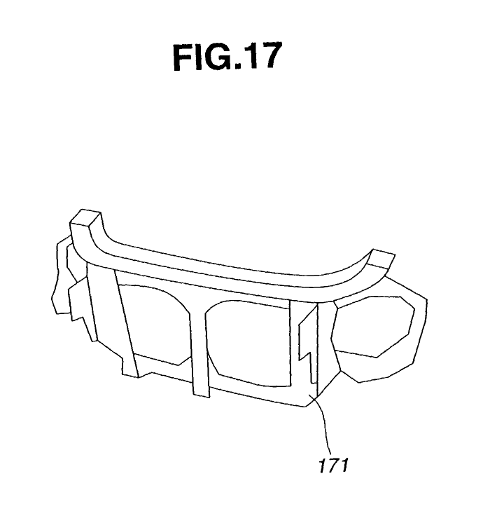

FIG. 17 shows a radiator core support 171 as a large vehicle part. Although a resinous radiator core support is appearing as a front end module, the resin composition of the present invention can make a part of higher heat resistance, chemical resistance and rigidity and lighter weight, and combine it with a fan shroud, a bracket, etc. The resin composition of the present invention can combine transparent parts, such as a radiator reservoir tank and a headlamp cover, as well as a bumper reinforcement which has hitherto been a separate member. Owing to its high heat and chemical resistance and low linear expansibility, the resin composition of the present invention is useful for combining parts in an engine compartment, such as an air cleaner and a throttle chamber. Although attempts have already been made to realize an integral combination of those parts, the engine compartment creates a severe environment by a high temperature and the presence of oil and other chemicals, and presents problems yet to be overcome by any traditional resinous material, but those problems can be overcome by the resin composition of the present invention. Similar results can be obtained from its application to an intake manifold and a cylinder head cover, and they can be combined with the parts mentioned above.

Although the integrally molded combination of the present invention can be formed from the resin composition of the present invention alone, it may also be composed of a multi-layer laminate formed by laminating the resin composition of the present invention with another resin. Such a laminate has at least one layer formed from the resin composition of the present invention, and preferably has its outermost and lowermost layers, and more preferably a middle layer, too, formed from the resin composition of the present invention. The multi-layer laminate provides additional functions not achieved by the resin composition of the present invention alone. The thermoplastic resin laminate as described before can be used as such a multi-layer laminate.

Owing to its high rigidity, heat resistance and dimensional stability after heating or molding, the resin composition of the present invention is suitable for an integrally molded combination including a part having a movable portion and an unmovable portion, such as a throttle chamber. Many parts having movable and unmovable portions are used in an intake or exhaust system or an air conditioning unit in a motor vehicle. These parts are mainly intended for controlling the flow of gas, such as air, and each part is composed of a cylindrical portion defining a gas passage and a cover which can be opened and closed to control the flow of the gas, and gas tightness is important for any such part, as is the case with, for example, each door for a throttle chamber or in an air conditioning unit. The cylindrical and cover portions of any such part formed from any traditional resinous material are so low in dimensional accuracy because of high degrees of molding shrinkage and thermal expansion that the cover portion is unsatisfactory in gas tightness. Heat resistance has been another problem imposed by any part for installation in an engine compartment. Owing to its low thermal expansibility and contractibility, and high heat resistance, the resin composition of the present invention can overcome those problems and make a part of high gas tightness. Owing to its high rigidity, the resin composition of the present invention can also achieve a reduction in weight of any such part and a corresponding improvement of its response.

Although a molded product having movable and unmovable portions according to the present invention can be made if its movable and unmovable portions are separately prepared by, for example, injection molding, and put together, its movable and unmovable portions are preferably made as an integral combination by, for example, two-color molding. In this way, it is possible to achieve a still higher level of gas tightness and a reduction in the number of process steps and parts.

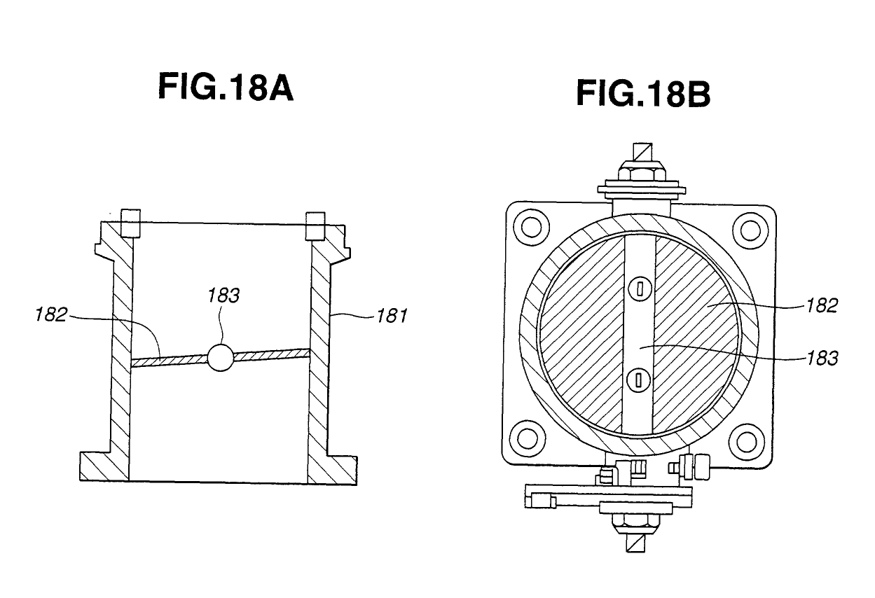

A throttle valve device of an intake system of an engine is shown in FIGS. 18A and 18B, which can be produced by a method which will now be described.

The throttle valve device has a cylindrical chamber portion 181 as an unmovable portion, a valve 182 as a movable portion and a metal shaft 183 for the valve. The metal shaft for the valve is first set in a mold for two-color molding, the cylindrical chamber portion is made by injection molding, a slide core is retracted for molding the circular valve, and the circular valve is made by injection molding. The metal shaft and the circular valve are united as an integral combination. This invention is also preferred for application to a cylindrically molded product having an unmovable portion for introducing a flowing gas, and a movable portion defining a cover to be opened or closed for controlling the flow of the gas.

Owing to its excellent property of shutting off any hydrocarbon fuel, its excellent property as a gas barrier and its high chemical resistance, the resin composition of the present invention is suitable for a part or container for holding any hydrocarbon fuel, such as a fuel tank or any other part of a fuel circuit in a motor vehicle, or an item for domestic use, such as kerosene container.

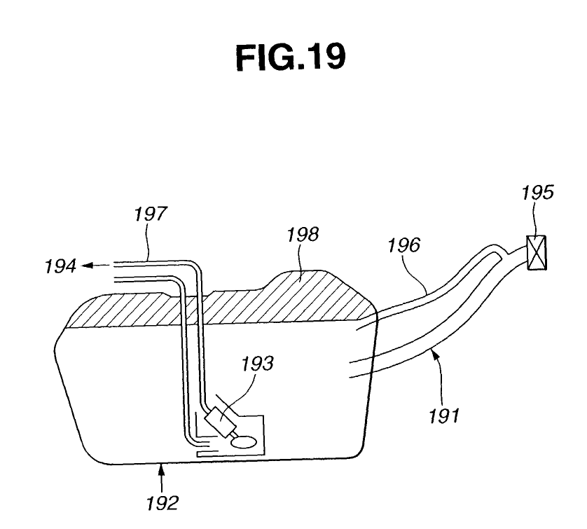

FIG. 19 shows a resinous fuel tank 198 in a motor, or other vehicle, as such a part or container. It shows a fuel circuit system in which gasoline, which is a hydrocarbon fuel, is introduced through a filler tube 191 for storage in a fuel tank 192, and is forced by a fuel pump 193 into an engine 194. The resin composition of the present invention is applicable to parts for the fuel circuit, such as fuel tank 192, a filler cap 195, a vent tube 196, a fuel hose 197, a fuel cutoff valve, a delivery valve, an evaporation tube, are turn tube and a fuel sender module. The fuel tank is the largest of the parts for the fuel circuit system in the vehicle. There has recently been an increasing use of a resinous material for fuel tanks, and owing to an increased freedom available in the selection of shapes for parts, a resinous tank can hold about 10 liters more fuel than a metallic one, and is about 25% lighter in weight. These advantages have brought about greater expectations for resinous fuel tanks. The following is a detailed statement of the present status of the use of a resinous material for fuel tanks and the problems involved therein.

It has been usual to use HDPE (high density polyethylene), an olefin resin, as a matrix resin for a fuel tank and blow molding as a method for producing it. While there has not been any great change in such material or method, there has been a great change in the layer structure of the tank. For example, the fuel tank was at first of the single layer type, but the enactment of the law for restraining the evaporation of hydrocarbons has made it essential to form a fuel tank with a multi-layer wall for reducing the permeation of hydrocarbons. As a result, fuel tanks are now mainly of a multi-layer wall structure composed of five layers of three kinds of materials, i.e. a mixture of HDPE and PA (polyamide), a mixture of HDPE and EVOH (ethylene-vinyl acetate copolymer) and HDPE on both sides. They are made by blow molding as usual.

The permeation of a large amount of hydrocarbon fuel through the wall of a single-layer type fuel tank is apparently due to good compatibility between the material of the tank and the fuel. HDPE has a solubility parameter of 7.9, while the hydrocarbon fuel has a SP of 6 to 8, and their SP's fall within the same range. On the other hand, PA used in the wall of a multi-layer type tank has a SP of 13.6 differing greatly from that of the fuel, or in other words, they are low in compatibility. Thus, the PA material in a multi-layer type fuel tank is employed as a barrier layer for preventing the escape of hydrocarbon fuel from the tank by permeation. The development of a multi-layer fuel tank has made it possible to establish a technique for satisfying the law for restraining the evaporation of hydrocarbons, but has brought about a-sharp increase in price of such tanks due to the complicated molding method which they require. Moreover, the laminated structure formed by a plurality of resins is not easy to recycle, but has presented a new problem in failing to cope with the current requirements of a recycling society.

The modified silica composition in the resin composition of the present invention has a SP exceeding 11 owing to the remaining silanol groups, and acts as a barrier against the permeation of hydrocarbon fuel like PA or EVOH as mentioned above. The resin composition consists mainly of a resin containing polar groups, such as acrylic, and having a SP above 11, which is low in compatibility with gasoline as hydrocarbon fuel, and a desirable material for fuel tanks. Thus, the resin composition of the present invention has been found to provide a fuel tank for a vehicle which satisfies legal regulations concerning the evaporation of hydrocarbons, even if it may be of the type having a single-layer wall. It has enabled a fuel tank to be manufactured at a low cost and also respond to the social requirements for recycling. The resin composition of the present invention is applicable not only to a fuel tank for a vehicle, but also to an article for domestic use, such as a kerosene container. It reduces the evaporation of kerosene into the air and contributes to preserving a sound global environment.

### EXAMPLES

The invention will now be described more specifically by examples. The present invention is, however, not limited thereto. The following is an explanation of methods employed for various kinds of evaluation.

(Evaluation of a Single-Layer Transparent Resin Composition)

(1) The total light transmittance was measured by a haze meter (HM-65 of Murakami Color Research Institute). A value of 75% or above was accepted.

(2) The distribution of the modified silica composition was observed by a transmission electron microscope (H-800 of Hitachi, Limited).

(3) The bending strength and elastic modulus were measured by an autograph (DCS-10T of SHIMADZU CORPORATION). A bending strength of 108 MPa or above was accepted.

(4) The coefficient of linear expansion was measured by a thermomechanical measuring instrument (TMA120C of Seiko Instruments inc.).

(Evaluation of a Laminate)

(1) The total light transmittance was measured by a haze meter (HM-65 of Murakami Color Research Institute). The evaluation was made as O: ≧90 and x: <90.

(2) The Rockwell hardness was measured by a Rockwell hardness meter (M scale). The evaluation was made as O: ≧95 and x: <95.

(3) The bending modulus was measured by an autograph (DCS-10T of SHIMADZU CORPORATION). The evaluation was made as O: ≧3500 MPa and x: <3500 MPa.

(4) Impact resistance: A 200 mm square laminate was fixed along all of its edges by a 180 mm square frame, a steel ball conforming to the JIS-R3212 impact resistance test method was allowed to fall from different heights, and the height which caused cracking was determined. The evaluation was made as O: ≧3 m and x: <3 m.

(5) Separation of layers: Each laminate was bent by about 90 degrees and was visually inspected for any separation of layers. The evaluation was made as O: No separation, and x: Separation found.

(6) Warpage: A test specimen measuring 100 mm by 50 mm was cut out from each laminate to be tested, was subjected 10 times to a cycle consisting of two hours of heating at 110° C. in an oven and allowing it to cool for at least two hours at room temperature, and was visually inspected for warpage (n=3). The evaluation was made as O: No warpage, and x: Warpage found.

### (Example 1—Preparation of Modified Silica)

A three-necked flask was charged with 2 g of finely particulate silica having an average primary particle diameter of 20 nm (Aerosil #90G of Nippon Aerosil Co., Ltd.) and 400 g of cyclohexane. While the silica was floating in a cyclohexane solution, 0.3 g of n-octadecyltrichlorosilane [CH₃(CH₂)₁₇SiCl₃] and 0.3 ml of pyridine as a catalyst were put in the solution, and the solution was heated to 80° C. and allowed for 2, 4, 6, 8 or 10 hours of treatment under reflux. In every case, silica was uniformly dispersed in cyclohexane and formed a cloudless transparent solution.

The hydrophobic ratio (A) of silica in each case was measured by FT-IR (viz., Fourier Transform Infrared Spectrophotometer). The results are shown in Table 1.

After such different hours of treatment, the reaction products were washed in cyclohexane to yield modified silica compositions having a modification factor (hydrophobic ratio×total carbon number) of 2.01 (designated as A-1), a modification factor of 4.45 (designated as A-2), a modification factor of 6.16 (designated as A-3), a modification factor of 8.00 (designated as A-4) and a modification factor of 8.12 (designated as A-5), respectively.

### (Example 2—Surface Modification of Silica)

0.1 g of di-n-butyldichlorosilane [CH₃(CH₂)₃SiCH₃(CH₂)₃Cl₂] was used as the modifying agent, and otherwise, Example 1 was repeated. The hydrophobic ratio (A) of silica (viz., of —OH) in each case was measured by FT-IR. The results are shown in Table 1.

After such different hours of treatment, the reaction products were washed in cyclohexane to yield modified silica compositions having a modification factor (hydrophobic ratio×total carbon number) of 1.07 (designated as B-1), a modification factor of 2.14 (designated as B-2), a modification factor of 3.05 (designated as B-3), a modification factor of 3.61 (designated as B-4) and a modification factor of 3.61 (designated as B-5), respectively.

### (Example 3—Surface Modification of Silica)

0.1 g of trimethylchlorosilane [(CH₃)₃SiCl ] was used as the modifying agent, and otherwise, Example 1 was repeated. The hydrophobic ratio (A) of silica (viz., of —OH) in each case was measured by FT-IR. The results are shown in Table 2.

After different hours of treatment, the reaction products were washed in cyclohexane to yield modified silica compositions having a modification factor (hydrophobic ratio×total carbon number) of 0.40 (designated as C-1), a modification factor of 0.45 (designated as C-2), a modification factor of 0.95 (designated as C-3), a modification factor of 1.35 (designated as C-4) and a modification factor of 1.34 (designated as C-5), respectively.

### (Example 4—Surface Modification of Silica)

Trimethylethoxysilane [(CH₃)₃SiOC₂H₅] was used as the modifying agent, no pyridine was used as the catalyst and otherwise, Example 1 was repeated. The hydrophobic ratio (A) of silica (viz., of —OH) in each case was measured by FT-IR. The results are shown in Table 2.

After different hours of treatment, the reaction products were washed in cyclohexane to yield modified silica compositions having a modification factor (hydrophobic ratio×total carbon number) of 0.25 (designated as D-1), a modification factor of 0.44 (designated as D-2), a modification factor of 0.78 (designated as D-3), a modification factor of 1.18 (designated as D-4) and a modification factor of 1.19 (designated as D-5), respectively.

### (Example 5—Manufacture of Transparent Resin Compositions)

The modified silica compositions as obtained in Examples 1 to 4 above were employed for the following processes. An acrylic resin solution having a resin content of 50% by weight was obtained by adding toluene to a granular polymethyl methacrylate resin (Acrypet VH of Mitsubishi Rayon Co., Ltd.). A total of 20 transparent resin compositions each containing 5 parts by weight of one of the modified silica compositions with 100 parts by weight of the polymethyl methacrylate resin were obtained by adding to 200 parts by weight of the resin solution 5 parts by weight of one of a total of 20 modified silica compositions, i.e. five as obtained in Example 1, five as obtained in Example 2, five as obtained in Example 3 and five as obtained in Example 4, mixing them under stirring, and causing sedimentation in ethanol for solidification.

Each resin composition as obtained was dried, granulated and extruded into a sheet having a thickness of 2 mm. Each sheet as obtained was measured for its total light transmittance and bending strength. A sheet not containing any modified silica composition was prepared as Comparative Example 1. The results are shown in Tables 1 and 2.

TABLE 1

| | Modified silica composition | | | | | Modified silica composition | | | | |
|---|---|---|---|---|---|---|---|---|---|---|
| | (Total carbon number: 18) | | | | | (Total carbon number: 8) | | | | |
| No. | A-1 | A-2 | A-3 | A-4 | A-5 | B-1 | B-2 | B-3 | B-4 | B-5 |
| Hydrophobic ratio | 11.2 | 24.7 | 34.2 | 44.5 | 45.1 | 13.4 | 26.7 | 38.1 | 45.2 | 45.1 |
| Modification factor | 2.01 | 4.45 | 6.16. | 8.00 | 8.12 | 1.07 | 2.14 | 3.05 | 3.61 | 3.61 |
| Total light transmittance, % | 90 | 91 | 92 | 92 | 92 | 90 | 90 | 90 | 91 | 91 |
| Bending strength, MPa | 123 | 118 | 114 | 109 | 95 | 125 | 125 | 125 | 123 | 123 |
| Overall evaluation | OK | OK | OK | OK | OK | OK | OK | OK | OK | OK |

TABLE 2

| | Modified silica composition | | | | | Modified silica composition | | | | | Comparative |
|---|---|---|---|---|---|---|---|---|---|---|---|
| | (Total carbon number: 3) | | | | | (Total carbon number: 3) | | | | | Example 1 |
| No. | C-1 | C-2 | C-3 | C-4 | C-5 | D-1 | D-2 | D-3 | D-4 | D-5 | PMMA |
| Hydrophobic ratio | 13.3 | 15.1 | 31.8 | 44.9 | 44.7 | 8.2 | 14.5 | 25.9 | 39.4 | 39.6 | — |
| Modification factor | 0.40 | 0.45 | 0.95 | 1.35 | 1.34 | 0.25 | 0.44 | 0.78 | 1.18 | 1.19 | — |
| Total light transmittance, % | 65 | 77 | 88 | 90 | 90 | 51 | 74 | 85 | 90 | 90 | 93 |
| Bending strength, MPa | 128 | 128 | 126 | 125 | 125 | 128 | 128 | 128 | 125 | 125 | 108 |
| Overall evaluation | NG | OK | OK | OK | OK | NG | NG | OK | OK | OK | — |

Three compositions C-1, D-1 and D-2 showed a total light transmittance not reaching the standard value of 75%, as shown in Tables 1 and 2. They had a modification factor of below 0.45 apparently due to the failure of silica to be made satisfactorily hydrophobic by the modifying agent to have a good affinity for the transparent resin and be satisfactorily dispersed in the polymethyl methacrylate resin. A-5 was inferior in bending strength, though its total light transmittance exceeded the standard value of 75%. As it had a modification factor of 8.12, it was apparent that its excessive modification had brought about a serious steric hindrance on the alkyl groups formed in the silica composition, and thereby hindered any interaction between the silanol groups in the modified silica composition and the hydrogen bonds in the matrix resin. These results on bending strength have made it possible to set a maximum modification factor of 8 according to the present invention. All of the other 16 transparent resin compositions showed a total light transmittance exceeding the standard value of 75%. They had a modification factor of 0.45 to 8, apparently due to the fact that fine particles of silica had been made adequately hydrophobic, and uniformly dispersed in the matrix resin without causing any trouble, such as coagulation. It is obvious from these results and from evaluation in view of transparency that silica is required to have a modification factor of at least 0.45 as the product of hydrophobic ratio and total carbon number. Its upper limit should be 8 in view of the results on bending strength, as stated above.

### (Example 6—Polymethyl Methacrylate Resin Containing Modified Silica Composition)

Example 5 was followed for preparing a solution of a polymethyl methacrylate resin (Acrypet VH of Mitsubishi Rayon Co., Ltd.) having a resin content of 50% by weight, adding to 200 parts by weight of the resin solution 0.8, 1, 3, 5, 10, 20, 40, 60, 80 or 100 parts by weight of modified silica composition B-3 as obtained in Example 2 to prepare 10 transparent resin compositions, and forming 10 transparent resin sheets. Each sheet was measured for its total light transmittance, silica dispersion, bending strength, bending modulus and coefficient of linear expansion. The results are shown in Table 3.

### (Example 7—Polycarbonate Resin Containing Modified Silica Composition)

A polycarbonate resin solution having a resin content of 50% by weight was obtained by adding methylene chloride to a granular polycarbonate resin (Iupilon S-1000 of Mitsubishi Engineering Plastics Corporation). Example 6 was followed for adding 20 parts by weight of modified silica composition (B-3) as obtained in Example 2 to 200 parts by weight of the resin solution and forming a transparent resin sheet consisting mainly of a polycarbonate resin and containing a modified silica composition. It was measured for its total light transmittance, silica dispersion, bending strength, bending modulus and coefficient of linear expansion. The results are shown in Table 4.

It was slightly inferior in transparency to the polymethyl methacrylate resin composition, but was rather superior in strength, etc., and was a transparent resin composition which was generally comparable to the polymethyl methacrylate resin composition.

### (Comparative Examples 2 and 3)

A granular polymethyl methacrylate resin (Acrypet VH of Mitsubishi Rayon Co., Ltd.) was extruded to form a sheet having a thickness of 2 mm as Comparative Example 2. A sheet was likewise formed from a granular polycarbonate resin (Iupilon S-1000 of Mitsubishi Engineering Plastics Corporation) as Comparative Example 3. Each sheet was measured for its total light transmittance, silica dispersion, bending strength, bending modulus and coefficient of linear expansion. The results are shown in Table 4. They were both high in transparency, but low in bending strength and modulus.

TABLE 3

| | Example 6 | | | | | | | | | |
|---|---|---|---|---|---|---|---|---|---|---|
| Modified silica proportion (parts by wt.) | 0.8 | 1 | 3 | 5 | 10 | 20 | 40 | 60 | 80 | 100 |
| Total light transmittance, % | 92 | 92 | 92 | 92 | 91 | 91 | 90 | 90 | 88 | 72 |
| Silica dispersion | Good | Good | Good | Good | Good | Good | Good | Fair | Fair | Bad |
| Bending strength, MPa | 108 | 108 | 113 | 118 | 125 | 131 | 135 | 137 | 139 | 141 |
| Bending modulus, GPa | 3.1 | 3.1 | 3.2 | 3.4 | 3.6 | 3.7 | 3.9 | 3.9 | 4.0 | 4.0 |
| Coefficient of linear expansion, × 10⁻⁵/ | 6.3 | 6.3 | 5.7 | 5.2 | 4.9 | 4.3 | 4.1 | 4.1 | 4.1 | 4.1 |
| sq. | | | | | | | | | | |

TABLE 4

| | | Comparative | Comparative |
|---|---|---|---|
| | Example 7 | Example 2 | Example 3 |
| Modified silica proportion (parts | 20 | 0 | 0 |
| by wt.) | | | |
| Total light transmittance, % | 92 | 93 | 92 |
| Silica dispersion | Good | — | — |
| Bending strength, MPa | 98 | 108 | 85 |
| Bending modulus, GPa | 2.7 | 3.1 | 2.3 |
| Coefficient of linear | 5.8 | 6.3 | 7.2 |
| expansion, × 10⁻⁵/sq. | | | |

As is obvious from the results of Examples 6 and 7 and Comparative Examples 2 and 3, the composition containing only less than 1 part by weight of modified silica was hardly improved in physical properties without making any substantial difference from any polymethyl methacrylate resin not containing any silica. The transparent resin composition containing more than 80 parts by weight of modified silica was hardly improved in physical properties, either, but was even lower in transparency. On the other hand, the transparent resin compositions containing 1 to 80 parts by weight of modified silica were improved in physical properties without having their transparency lowered. The increase in the proportion of the modified silica composition, however, added to its specific gravity and thereby the weight of any product formed therefrom. Thus, it is preferable to employ 3 to 40 parts by weight of surface-modified silica composition with 100 parts by weight of transparent resin.

### (Example 9)

A modified silica composition in powder form (having a modification factor of 3.05) was prepared by dispersing in hexane finely particulate silica having an average primary particle diameter of 10 to 20 nm (Aerosil #90G of Nippon Aerosil Co., Ltd.) and substituting alkyl groups for a part of its silanol groups by using n-decyltrichlorosilane as the modifying agent. The composition was dissolved in toluene to form a solution having a concentration of 10% by weight. The solution was mixed under stirring with a solution prepared by dissolving a methyl methacrylate resin (Acrypet VH of Mitsubishi Rayon Co., Ltd.) in toluene and having a concentration of 50% by weight to have silica dispersed uniformly in the resin solution, and 20 parts by weight of hexane were added to the solution as a solidifying solvent to cause sedimentation, and the sediment was dried in a vacuum dryer to have the solvent removed by evaporation to yield an acrylic resin composition containing 5% by weight of modified silica composition. If fine particles of silica are mixed with a molten resin, they usually undergo coagulation and make the solution opaque, but it is possible to obtain a transparent resin composition of high transparency if a solution of a modified silica composition and a solution of a transparent amorphous resin are mixed to undergo sedimentation with a solidifying solvent to form a uniform silica dispersion, as described above.

The acrylic resin composition was pelletized, and the visual inspection of its pellets did not reveal any cloudiness produced by the coagulation of silica, or any silica particle.

The acrylic resin composition (C) and a polycarbonate resin not containing any silica (Iupilon E200U of Mitsubishi Engineering Plastics Corporation) were extruded together through two extruders to form a three-layer laminate composed of a surface layer of resin C having a thickness of 1 mm, a middle layer of resin D having a thickness of 3 mm and a lower layer of resin C having a thickness of 1 mm. The laminate was evaluated for various properties as stated before. The results are shown in Table 5.

### (Example 10)

A laminate was made by preparing a resin composition containing 1% by weight of the modified silica composition and otherwise repeating Example 9, and was likewise evaluated. The results are shown in Table 5.

### (Example 11)

A laminate was made by preparing a resin composition containing 10% by weight of the modified silica composition and otherwise repeating Example 9, and was likewise evaluated. The results are shown in Table 5.

### (Example 12)

A laminate was made by preparing a resin composition containing 40% by weight of the modified silica composition and otherwise repeating Example 9, and was likewise evaluated. The results are shown in Table 5.

### (Example 13)

A laminate was made by lowering the discharge capacity of the extruders and changing the widths of slits of the T-dies to form a surface layer of transparent resin composition C having a thickness of 0.1 mm, a middle layer of resin D having a thickness of 0.3 mm and a lower layer of transparent resin composition C having a thickness of 0.1 mm and otherwise repeating Example 9, and was likewise evaluated. The results are shown in Table 5.

### (Example 14)

A laminate was made by lowering the discharge capacity of the extruders and changing the widths of slits of the T-dies to form a surface layer of transparent resin composition C having a thickness of 2 mm, a middle layer of resin D having a thickness of 6 mm and a lower layer of transparent resin composition C having a thickness of 2 mm and otherwise repeating Example 13, and was likewise evaluated. The results are shown in Table 5.

### (Example 15)

A laminate was made by employing finely particulate silica having an average primary particle diameter of 200 to 250 nm to prepare a modified silica composition and otherwise repeating Example 9, and was likewise evaluated. The results are shown in Table 5.

### (Example 16)

A laminate having five layers composed alternately of transparent resin composition C and resin D was made by controlling the discharge capacity of the extruders and employing T-dies adapted to form a laminate of five layers. The layers of resins C/D/C/D/C had a thickness of 0.7, 1.5, 0.6, 1.5 and 0.7 mm, respectively. The results of its evaluation are shown in Table 5.

### (Comparative Example 4)

A three-layer laminate having a thickness of 5 mm was made by employing an acrylic resin not containing any modified silica composition (referred to as resin C′) and otherwise repeating Example 9, and was likewise evaluated. The results are shown in Table 5.

TABLE 5

| | | Example | | | | | | | Comparative |
|---|---|---|---|---|---|---|---|---|---|
| | Example 9 | 10 | Example 11 | Example 12 | Example 13 | Example 14 | Example 15 | Example 16 | Example 4 |
| Sample | | | | | | | | | |
| Number of layers | 3 | 3 | 3 | 3 | 3 | 3 | 3 | 5 | 3 |
| Layer arrangement (*1) | c/d/c | c/d/c | c/d/c | c/d/c | c/d/c | c/d/c | c/d/c | c/d/c/d/c | c′/d/c′ |
| Laminate thickness (mm) | 5 | 5 | 5 | 5 | 0.5 | 10 | 5 | 5 | 5 |
| Silica content (wt. %) | 5 | 1 | 10 | 40 | 5 | 5 | 8 | 5 | 0 |
| Evaluation | | | | | | | | | |
| Total light transmittance | ∘ | ∘ | ∘ | ∘ | ∘ | ∘ | ∘ | ∘ | ∘ |
| Rockwell hardness | ∘ | ∘ | ∘ | ∘ | ∘ | ∘ | ∘ | ∘ | x |
| Bending modulus | ∘ | ∘ | ∘ | ∘ | ∘ | ∘ | ∘ | ∘ | ∘ |
| Impact resistance | ∘ | ∘ | ∘ | ∘ | ∘ | ∘ | ∘ | ∘ | ∘ |
| Layer separation | ∘ | ∘ | ∘ | ∘ | ∘ | ∘ | ∘ | ∘ | x |
| Warpage | ∘ | ∘ | ∘ | ∘ | ∘ | ∘ | ∘ | ∘ | x |
| Overall evaluation | ∘ | ∘ | ∘ | ∘ | ∘ | ∘ | ∘ | ∘ | x |

*1: Layer C—Acrylic resin + modified silica composition;
Layer D—Polycarbonate resin (not containing any modified silica);
Layer C′—Acrylic resin (not containing any modified silica).

What is claimed is:

1. A modified silica composition comprising:
finely particulate silica with silanol groups, said finely particulate silica being so modified as to have a modification factor of approximately 0.45 to approximately 8 as expressed by the product (A×B) of the hydrophobic ratio (A) of the silanol groups and the total carbon number (B) of alkyl groups.

2. The composition as claimed in claim 1, in which said silica is granular and has an average primary particle diameter smaller than 380 nm.

3. The composition as claimed in claim 2, in which the average primary particle diameter is from approximately 5 nm to approximately 50 nm.

4. A transparent resin composition (C) comprising the modified silica composition as claimed in claim 1 and a transparent resin.

5. The transparent resin composition (C) as claimed in claim 4, in which said transparent resin is one of materials that include (meth)acrylic, polycarbonate and polystyrene type polymer materials.

6. The transparent resin composition (C) as claimed in claim 4, said composition (C) containing 1 to 80 parts by weight of the modified silica composition with 100 parts by weight of the transparent resin.

7. A thermoplastic resin laminate comprising at least one layer of the transparent resin composition (C) and at least one layer of the thermoplastic resin (D) as claimed in claim 4, the layers of the transparent resin composition (C) and the layers of the thermoplastic resin (D) being alternatively layered.

8. The thermoplastic resin laminate as claimed in claim 7, in which the transparent resin composition (C) and the thermoplastic resin (D) are welded together.

9. The thermoplastic resin laminate as claimed in claim 7, in which the thermoplastic resin (D) is a polycarbonate resin.

10. The thermoplastic resin laminate as claimed in claim 7, in which the alternative layers are those formed in an odd number of at least three, and include an uppermost layer and a lowermost layer which are both formed from the transparent resin composition (C) or the thermoplastic resin (D).

11. A molded product for use in a vehicle, that is made by using the modified silica composition as claimed in claim 1.

12. A molded product for use in a vehicle, that is made by using the transparent resin composition as claimed in claim 4.

13. A molded produce for use in a vehicle, that is made by using the thermoplastic resin laminate as claimed in claim 7.

14. A method for producing a modified silica composition, comprising:
modifying finely particulate silica with a silicone compound expressed by any of formulas below: 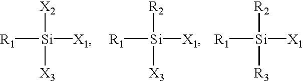
wherein R₁, R₂ and R₃ stand, independently of one another, for an alkyl group having 1 to 20 carbon atoms, and X₁, X₂ and X₃ stand, independently of one another, for a chlorine atom, a hydrogen atom or an alkoxy group having 1 to 8 carbon atoms.

15. A method for producing the transparent resin composition (C) as claimed in claim 4, comprising mixing a solution of said modified silica composition and a solution of said transparent resin.

16. A method for producing the thermoplastic resin laminate as claimed in claim 7, comprising laying the layers together by hot and/or pressure forming.

17. A method for producing a molded product for use in a vehicle, comprising:
inserting the thermoplastic resin laminate as claimed in claim 7 in a mold; and
feeding a molten resin into the mold around said laminate to form a unitary product by using injection or compression molding.

18. A resinous wiper system formed from the resin composition as claimed in claim 4.

19. A resinous door mirror stay formed from the resin composition as claimed in claim 4.

20. A resinous pillar formed from the resin composition as claimed in claim 4.

21. A molded resin product having a transparent portion and an opaque portion, at least the transparent portion being formed from the resin composition as claimed in claim 4.

22. The product as claimed in claim 21, in which the transparent and opaque portions are combined to form an integrally molded assembly.

23. The product as claimed in claim 21, in which the opaque portion is formed by coloring by a pigment dispersed in the resin.

24. The product as claimed in claim 21, in which the opaque portion is formed by painting or printing before or after molding.

25. The product as claimed in claim 21, in which the opaque portion is formed by a colored sheet.

26. A resinous window pane with heat rays, which is formed from the resin composition as claimed in claim 4.

27. A resinous mirror formed from the resin composition as claimed in claim 4.

28. A resinous lamp reflector formed from the resin composition as claimed in claim 4.

29. A resinous cover member for use in an engine compartment, which is formed from the resin composition as claimed in claim 4.

30. The cover member as claimed in claim 29, which is transparent.

31. A resinous cooler part formed from the resin composition as claimed in claim 4.

32. An integrally molded resin product formed from the resin composition as claimed in claim 4, in which said product has a hollow structure communicating with the open air and/or a closed hollow structure.

33. The product as claimed in claim 32, in which the hollow structure holds a gas, liquid or solid, or a mixture thereof, and is closed.

34. The product as claimed in claim 32, in which the product has an outermost layer formed from an ornamental material.

35. The product as claimed in claim 32, in which the product forms an outer panel for a motor vehicle, or apart for its interior or exterior decoration.

36. A method for producing the integrally molded resin product as claimed in claim 31, comprising:
heating two resin sheets formed from the resin composition as claimed in claim 4;
inserting said two resin sheets in an open mold;
introducing a pressurized fluid between the two resin sheets before or after pressing the sheets along their edges to weld their edges together; and
closing the mold to maintain the pressure of the pressurized fluid to form a hollow structure, while stretching the sheets.

37. A method for producing the integrally molded resin product as claimed in claim 32, comprising:
filling a closed mold with a molten material of the resin composition as claimed in claim 4; and
introducing a pressurized fluid into the molten material to form a hollow structure, while expanding the volume of the mold cavity.

38. A method for producing the integrally molded resin product as claimed in claim 32, comprising:
inserting along the cavity surface of an open mold one or two resin sheets formed from the resin composition as claimed in claim 4;
closing the mold;
introducing a molten resin to fill the mold between the two sheets or behind the one sheet; and
introducing a pressurized fluid into the molten resin to form a hollow structure, while expanding the volume of the cavity.

39. An integrally molded product formed from the resin composition as claimed in claim 4, and including at least two parts having different functions to form a single part capable of performing at least two functions.

40. A molded product including a movable portion and an unmovable portion, and formed from the resin composition as claimed in claim 4.

41. The molded product as claimed in claim 40, in which the movable and unmovable portions are made as an integral assembly by two-color molding.

42. The molded product as claimed in claim 40, in which the movable portion is a cover which opens and closes to control the flow of gas, and in which the unmovable portion is a cylindrical body for admitting the flowing gas.

43. A container for storing hydrocarbon fuel, which is formed from the resin composition as claimed in claim 4.

44. The container as claimed in claim 43, which is a part of a fuel circuit in a motor vehicle.

45. The container as claimed in claim 44, which is a fuel tank for a motor vehicle.

46. The container as claimed in claim 45, which is a fuel tank made by blow molding.

47. A modified silica composition as claimed in claim 1, in which said finely particulate silica is modified to have the modification factor of approximately 0.45 to approximately 4.

48. A modified silica composition as claimed in claim 1, in which said finely particulate silica is modified to have the modification factor of approximately 0.5 to approximately 2.
